(19) United States
(12) Patent Application Publication
(10) Pub. No.: US 2026/0285131 A1
(43) Pub. Date: Sep. 24, 2026

(54) FRAGRANCE DIFFUSER FOR CONTROLLED EVAPORATIVE RELEASE OF FRAGRANCE

(71) Applicant: Daniel Rytel, Naples, FL (US)

(72) Inventor: Daniel Rytel, Naples, FL (US)

(21) Appl. No.: 19/574,265

(22) Filed: Mar. 21, 2026

Related U.S. Application Data
(60) Provisional application No. 63/775,359, filed on Mar. 21, 2025.
(60) Provisional application No. 63/971,181, filed on Jan. 29, 2026.

(51) Int. Cl. B60H 3/00; H01F 7/02

(52) U.S. Cl. CPC B60H 3/0028; B60H 2003/0042; B60H 2003/0057; H01F 7/0252

(57) ABSTRACT

A fragrance diffuser comprising a housing with airflow apertures, a fragrance cartridge containing liquid fragrance, a dispensing assembly configured to deliver liquid fragrance upon actuation, and a replaceable absorbent diffusion medium positioned within the housing. The dispensing assembly dispenses liquid fragrance directly to the absorbent diffusion medium, from which fragrance evaporates and exits the housing through the airflow apertures. In various embodiments, the dispensing assembly comprises a manually-actuated pump mechanism, a gravity-fed valve-based system, or an electronically-actuated pump. The cartridge may have a dual-neck configuration enabling a modular architecture in which a pump assembly attaches to a first neck and the resulting subassembly removably attaches to the housing via a second neck, permitting tool-free replacement of the cartridge and diffusion medium. Mounting configurations include a magnetic vent-clip interface and a multi-position mounting loop. The diffusion medium architecture provides on-demand fragrance refreshing, leak resistance, and user serviceability across all embodiments.

### REFERENCE TO RELATED APPLICATIONS

This application claims the benefit of U.S. Provisional Patent Application No. 63/775,359, filed Mar. 21, 2025, titled “Self-Contained Refreshable Air Freshener Diffuser,” and U.S. Provisional Patent Application No. 63/971,181, filed Jan. 29, 2026, titled “Self-Contained Refreshable Air Freshener Diffuser with Modular Pump Assembly,” the entire disclosures of which are incorporated herein by reference.

### FIELD OF THE INVENTION

The present disclosure relates generally to air freshener devices and, more particularly, to a fragrance diffuser for controlled evaporative release of fragrance.

### BACKGROUND OF THE INVENTION

Fragrance devices for vehicles and enclosed spaces are widely used to improve air quality and occupant comfort. Existing products generally fall into two categories: passive diffusers that rely on continuous evaporation from a saturated medium or exposed liquid, and active diffusers that use electronic mechanisms to disperse fragrance into the air.

Passive diffusers—including hanging cardboard air fresheners, vent-clip gel canisters, and reed-style diffusers—offer simplicity and low cost but provide limited user control over fragrance intensity. Once activated, these products emit fragrance at a rate determined by ambient conditions, and the user has no convenient means to increase intensity on demand or to pause emission. Fragrance strength typically diminishes steadily after activation, and the entire product must be replaced when the fragrance source is exhausted.

Electronic diffusers address some of these limitations by using battery-powered pumps, fans, or heating elements to disperse fragrance on a schedule or on demand. However, electronic diffusers introduce additional cost, complexity, and maintenance requirements, including battery replacement or recharging. Many electronic diffusers atomize liquid fragrance directly into the air at low concentrations, which can result in inconsistent scent delivery and rapid dissipation.

Some prior art devices employ absorbent media in contact with liquid fragrance reservoirs, relying on continuous wicking or capillary contact to transfer liquid to the medium for evaporation. While this approach can provide sustained fragrance release, the continuous liquid contact causes rapid depletion of the fragrance source, may saturate the medium with non-volatile residues, and provides the user with limited ability to modulate fragrance strength. Additionally, devices with continuous liquid-medium contact may present leakage risks, particularly in vehicle environments where the device is subject to movement, vibration, and varying orientations.

There exists a need for a fragrance diffuser that combines the simplicity and low cost of passive designs with user-controlled, on-demand fragrance delivery, while avoiding the complexity and power requirements of electronic systems. There is a further need for a modular diffuser architecture that enables tool-free replacement of consumable components—including the fragrance source and the diffusion medium—to support long-term use and fragrance customization.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

In one aspect, the present disclosure provides a fragrance diffuser comprising a housing having airflow apertures, a fragrance cartridge containing liquid fragrance, a manually-actuated pump mechanism in fluid communication with the cartridge, and an absorbent diffusion medium positioned within the housing. Actuation of the pump mechanism dispenses liquid fragrance directly to the absorbent diffusion medium, from which fragrance evaporates and exits the housing through the airflow apertures. The pump mechanism may include a liquid distribution structure configured to deliver liquid fragrance to multiple spatially separated locations within the medium, and the diffuser may include a magnetic interface for detachable mounting to a vent clip.

In another aspect, the present disclosure provides a fragrance diffuser system featuring a modular architecture based on a fragrance cartridge having a first neck and a second neck. A pump assembly attaches to the first neck, forming a pump-cartridge subassembly, and the subassembly removably attaches to a diffuser shell via the second neck. An absorbent diffusion medium is positioned around or adjacent to the pump assembly output region. The pump-cartridge subassembly and diffusion medium are removable from the shell as a unit, enabling tool-free replacement of the diffusion medium or cartridge.

In a further aspect, the present disclosure provides a fragrance diffuser comprising an actuation element at a first end, a pump mechanism at a second end opposite the first end, an absorbent diffusion medium positioned between the actuation element and the pump mechanism, and a force transmission member configured to transmit actuation force from the actuation element to the pump mechanism through or around the diffusion medium.

In yet another aspect, the present disclosure provides a method of refreshing fragrance in an enclosed space comprising manually actuating a pump mechanism to dispense liquid fragrance to an absorbent diffusion medium, permitting evaporation, and repeating the actuation to refresh fragrance intensity. The method may further comprise removing and replacing the cartridge and diffusion medium using the modular architecture.

In additional aspects, the present disclosure provides a fragrance diffuser with a valve-based dispensing system operable by inverting the diffuser with an actuator engaged to deliver liquid fragrance by gravity to the diffusion medium; a mounting system comprising a loop element rotatably attached to the diffuser body and movable between a hanging orientation and a clip-mounting orientation; and an electronic variant comprising a battery-powered pump and electronic control circuit configured to actuate the pump in response to a timer, user input, or sensor input, while retaining the absorbent diffusion medium architecture for fragrance delivery.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front view of a fragrance diffuser 1, in accordance with some embodiments.

FIG. 2 is a disassembled view of the fragrance diffuser 1, in accordance with some embodiments.

FIG. 3 is a front cross-sectional view of the fragrance diffuser 1, in accordance with some embodiments.

FIG. 4A is a perspective view of the fragrance diffuser 1 comprising a loop element 70 with a strap 76, in accordance with some embodiments.

FIG. 4B is a perspective view of the fragrance diffuser 1 comprising the loop element 70 with a hook 71, in accordance with some embodiments.

FIG. 4C is a perspective view of the fragrance diffuser 1 comprising the loop element 70 with a magnetic interface 74, in accordance with some embodiments.

FIG. 5A is a perspective view of the pump assembly 30 attached to the fragrance cartridge 40 comprising a plurality of radial tubes 80, in accordance with some embodiments.

FIG. 5B is a perspective cross-sectional view of the pump assembly 30 attached to the fragrance cartridge 40 and the absorbent diffusion medium 20, comprising the plurality of radial tubes 80, in accordance with some embodiments.

FIG. 5C is a partial front cross-sectional view of the pump assembly 30 comprising the plurality of radial tubes 80, in accordance with some embodiments.

FIG. 6A is a front view of the fragrance diffuser 1 comprising a valve-based dispensing system 100 in an original state, in accordance with some embodiments.

FIG. 6B is a front view of the fragrance diffuser 1 comprising the valve-based dispensing system 100 in an inverted state, in accordance with some embodiments.

FIG. 7A is a perspective view of the fragrance diffuser 1 comprising a vent clip 60, in accordance with some embodiments.

FIG. 7B is a disassembled side perspective view of the fragrance diffuser 1 comprising the vent clip 60, in accordance with some embodiments.

FIG. 7C is a disassembled rear perspective view of the fragrance diffuser 1 comprising the vent clip 60, in accordance with some embodiments.

FIG. 7D is a side cross-sectional view of the fragrance diffuser 1 comprising the vent clip 60 attached to an air vent 63, in accordance with some embodiments.

FIG. 8A is a partial front cross-sectional view of the fragrance diffuser 1 comprising a plunger 50, in accordance with some embodiments.

FIG. 8B is a partial front cross-sectional view of the fragrance diffuser 1 comprising an extension 112, in accordance with some embodiments.

FIG. 8C is a partial front cross-sectional view of the fragrance diffuser 1, in accordance with some embodiments.

FIG. 9A is a top perspective view of the absorbent diffusion medium 20, in accordance with some embodiments.

FIG. 9B is a top perspective cross-sectional view of the absorbent diffusion medium 20, in accordance with some embodiments.

FIG. 10A is a top perspective view of an absorbent diffusion medium 23 of an annular disc configuration, in accordance with some embodiments.

FIG. 10B is a top perspective view of an absorbent diffusion medium 24 of a lattice configuration, in accordance with some embodiments.

FIG. 10C is a top perspective view of an absorbent diffusion medium 25 of a grid configuration, in accordance with some embodiments.

FIG. 10D is a top view of an absorbent diffusion medium 26 of a multiple discrete elements configuration, in accordance with some embodiments.

FIG. 10E is a bottom perspective view of an absorbent diffusion medium 27 of a gear configuration, in accordance with some embodiments.

FIG. 11 is a front cross-sectional view of the fragrance diffuser 1 with an orientation sensor 132, in accordance with some embodiments.

FIG. 12A is a front cross-sectional view of the fragrance diffuser 1 with a dish element 86, comprising a plurality of apertures 87, in accordance with some embodiments.

FIG. 12B is a front cross-sectional view of the fragrance diffuser 1 with a dish element 89, comprising a plurality of apertures 90, in accordance with some embodiments.

FIG. 13 is a front cross-sectional view of the plurality of radial tubes 80 with one or more holding chambers 94, in accordance with some embodiments.

FIG. 14A is a top perspective view of a dish element 91 with a flat top surface 92 comprising the plurality of apertures 87, in accordance with some embodiments.

FIG. 14B is a top perspective view of the dish element 91 with the flat top surface 92 comprising a plurality of channels 88 and the plurality of apertures 87, in accordance with some embodiments.

FIG. 14C is a top perspective view of the dish element 91 with a recessed top surface 95 comprising the plurality of apertures 87, in accordance with some embodiments.

FIG. 15A is a top view of a dish element 96 with a flat top surface 92 comprising a plurality of apertures 87 and a plurality of channels 88, in accordance with some embodiments.

FIG. 15B is a top perspective view of the dish element 96 with a recessed top surface 95 comprising the plurality of apertures 87 and the plurality of channels 88, in accordance with some embodiments.

FIG. 16 is a block diagram of the fragrance diffuser 1, in accordance with some embodiments.

FIG. 17 is a front view of a fragrance diffuser 140 comprising two fragrance cartridges 141-142, in accordance with some embodiments.

FIG. 18A is a top perspective view of the housing 10 comprising an airflow-modifying structure 130, in accordance with some embodiments.

FIG. 18B is a top perspective view of the airflow-modifying structure 130, in accordance with some embodiments.

FIG. 19A is a top perspective view of the housing 10 comprising an airflow-modifying structure 131, in accordance with some embodiments.

FIG. 19B is a top perspective view of the airflow-modifying structure 131, in accordance with some embodiments.

FIG. 20 is a flowchart of a method 2000 for controlled evaporative release of fragrance, in accordance with some embodiments.

FIG. 21 is a flowchart of a method 2100 for controlled evaporative release of fragrance comprising reinstalling a pump-cartridge-medium assembly into the housing, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a fragrance diffuser.

### OVERVIEW

The following description sets forth specific embodiments of a fragrance diffuser system in sufficient detail to enable a person of ordinary skill in the art to make and use the invention. It is to be understood that the embodiments described herein are exemplary and that the invention is not limited to these specific configurations. Various modifications, substitutions, and rearrangements may be made without departing from the scope of the appended claims.

Throughout this description, like reference numerals refer to like elements across all figures. When an element is first introduced, it is accompanied by a reference numeral in parentheses. Subsequent references to the same element use the reference numeral without additional explanation.

As used herein, ‘dispensing assembly’ refers broadly to any mechanism configured to dispense liquid fragrance upon actuation, including but not limited to the manually-actuated pump mechanism 56, the valve-based dispensing system 100, and the electronically-actuated pump mechanism described herein.

### Primary Embodiment—General Description

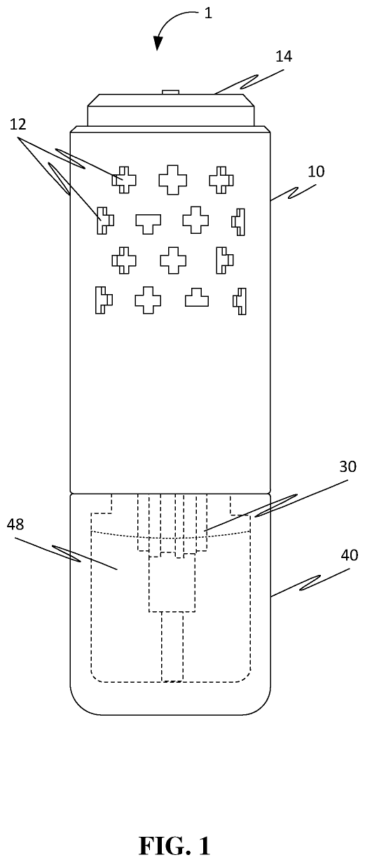

Referring now to FIGS. 1-3, the fragrance diffuser (1) of the present disclosure comprises four primary components arranged along a common longitudinal axis: a housing 10 (also referred to herein as the shell or diffuser body), an absorbent diffusion medium 20, a pump assembly 30, and a fragrance cartridge 40. These components are configured for assembly and disassembly by a user without requiring tools, enabling replacement of the diffusion medium 20 and cartridge 40 as part of routine maintenance.

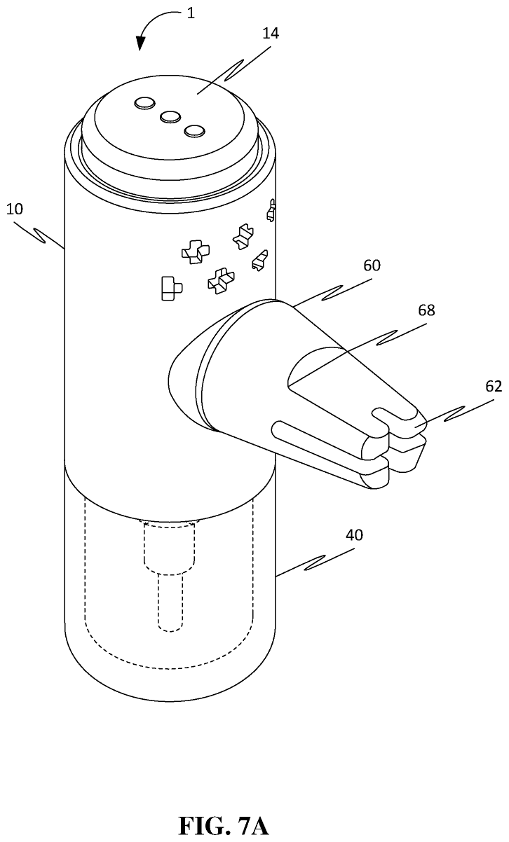

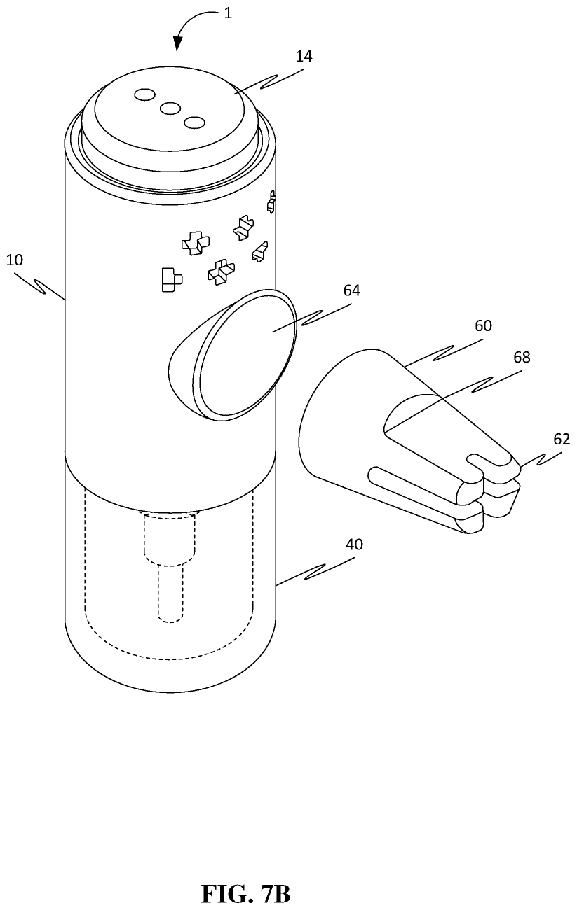

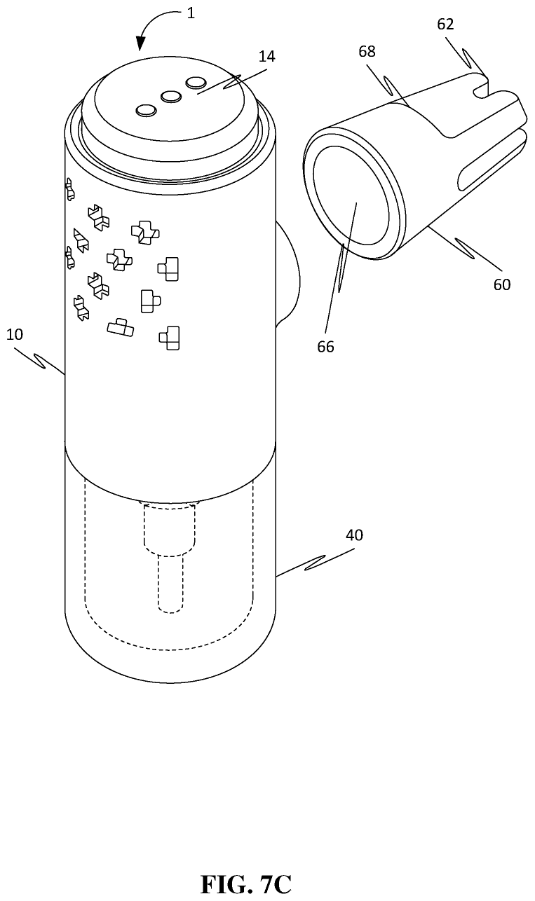

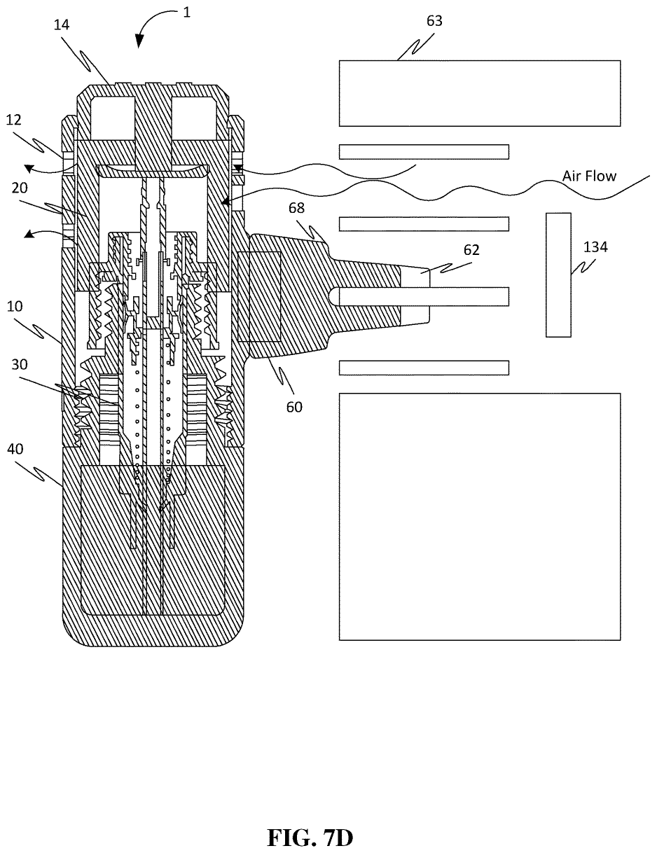

In the assembled configuration shown in FIG. 1, the housing 10 encloses the diffusion medium 20 and the upper portion of the pump assembly 30, while the fragrance cartridge 40 is secured to the housing 10 via a threaded or other mechanical interface. An actuation button 14 is positioned at the top of the housing 10 and is accessible to the user for on-demand fragrance dispensing. The actuation button 14 is one form of actuation element; in alternative embodiments, the actuation element may comprise a twist actuator, sliding actuator, or other manually-engageable input. A vent clip 60 (as shown in FIGS. 7A-7D) extends from a rear surface of the housing 10 for mounting the assembled diffuser to a vehicle air vent.

In one exemplary embodiment, the assembled diffuser has an overall height of approximately 93 mm, including the actuation button 14, and a diameter of approximately 30 mm. These dimensions are provided for illustration and are not limiting; the diffuser may be scaled larger or smaller for different applications or cartridge capacities.

### Housing

Referring to FIGS. 1-3, the housing 10 defines an interior volume sized to receive the diffusion medium 20 and the output region of the pump assembly 30. The housing 10 includes a plurality of airflow apertures 12 (also referred to herein as perforations) formed through its wall surfaces. These apertures 12 are positioned on the front and rear surfaces, or circumferentially around the housing 10, to facilitate airflow through the interior volume. In use, ambient air or air forced through a vehicle air vent enters through one set of apertures 12, passes over and through the diffusion medium 20, and exits through opposing apertures 12, carrying fragrance vapor into the surrounding environment.

The housing 10 may be constructed from injection-molded polymer, die-cast or machined metal, hybrid metal-polymer construction, or composite materials. Surface finishes may include anodized, painted, coated, or textured treatments. In some embodiments, the housing 10 is opaque. In other embodiments, the housing 10 may be translucent or transparent, or may include one or more transparent windows, to permit the user to observe the state of the diffusion medium 20 or cartridge 40 without disassembly. In further embodiments, the outer shell of the housing 10 is interchangeable, allowing users to customize the appearance of the diffuser while retaining the same internal components.

The housing 10 includes an attachment interface (55) at its lower end for securing the fragrance cartridge 40 or the pump-cartridge subassembly. In the preferred embodiment, the attachment interface 55 is threaded, comprising internal threads that engage corresponding external threads on the second neck 44 (lower neck) of the fragrance cartridge 40 (described below). In alternative embodiments, the attachment interface 55 may employ a snap-fit connection, bayonet-style twist-lock mechanism, clip-in retention system, or friction-fit interface.

In embodiments configured for vent-clip mounting, the housing 10 includes a magnetic element 64 on its rear surface (see FIGS. 7A-7D). A vent clip 60 includes a corresponding magnetic element 66 and a vent blade grip 68 for securing the clip to a vehicle air vent blade. The magnetic connection between elements 64 and 66 enables the diffuser to be attached to and detached from the vent clip 60 without tools, while maintaining secure retention during normal vehicle operation including vibration and moderate accelerations. The vent clip 60 and its spring or grip mechanism 62 are configured to accommodate a range of vent blade thicknesses commonly found in automotive HVAC systems.

### Fragrance Cartridge

Referring to FIGS. 1-3, the fragrance cartridge 40 is a container holding a reservoir 46 of liquid fragrance 48. In the preferred embodiment, the cartridge 40 is constructed of transparent or translucent glass or polymer material, allowing the user to visually monitor the liquid fragrance level and determine when replacement or refilling is needed.

The fragrance cartridge 40 features a dual-neck configuration, which is a central aspect of the modular architecture described herein. The cartridge 40 has a first neck 42 configured for attachment to the pump assembly 30 (positioned as the upper neck in the preferred stacked embodiment) and a second neck 44 configured for attachment to the housing 10 (positioned as the lower neck in the preferred stacked embodiment). In the preferred embodiment, the first neck 42 and second neck 44 are axially stacked along the longitudinal axis of the cartridge 40, with the first neck 42 positioned above the second neck 44 and having a smaller outer diameter than the second neck 44. In an alternative embodiment, the first neck 42 and second neck 44 may be concentrically arranged on a common plane perpendicular to the longitudinal axis of the cartridge 40, with the first neck 42 positioned radially inward of the second neck 44.

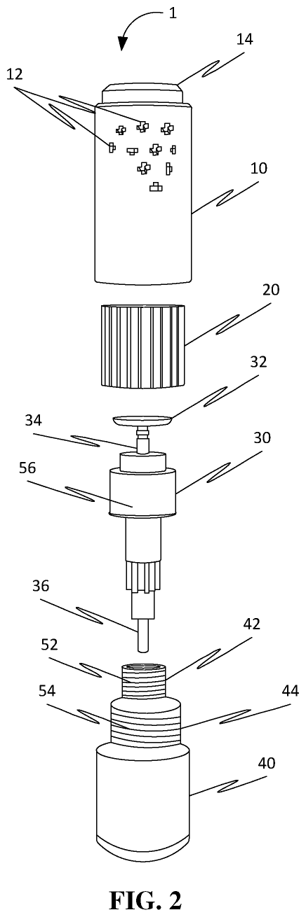

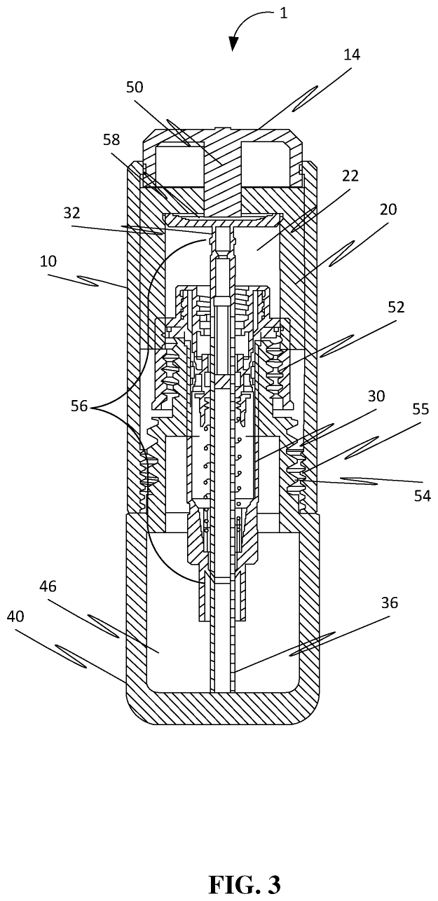

The first neck 42 provides the attachment point for securing the pump assembly 30 to the cartridge 40. In the preferred embodiment, the pump assembly 30 attaches to the first neck 42 via threaded engagement at a threaded interface 52 (see FIGS. 2-3). The second neck 44 provides the attachment point for securing the cartridge-pump unit to the housing 10. In the preferred embodiment, the second neck 44 attaches to the housing 10 via threaded engagement at a threaded interface 54 (see FIGS. 2-3).

In alternative embodiments, one or both attachment points may employ snap-fit connections, bayonet-style twist-lock mechanisms, clip-in retention systems, or friction-fit interfaces. The attachment method at each interface may differ; for example, the pump-to-cartridge interface at the first neck 42 may be threaded while the cartridge-to-housing interface at the second neck 44 employs snap-fit retention, or vice versa.

This dual-neck design creates a sealed, modular unit wherein the pump assembly 30 and cartridge 40 travel together as a pump-cartridge subassembly during disassembly from the housing 10, simplifying the replacement process.

The cartridge 40 may be configured as a single-use disposable cartridge pre-filled by the manufacturer, or as a user-refillable cartridge with a removable cap or septum. Different cartridges may have different reservoir volumes for different use durations. The cartridge 40 is designed to minimize or prevent leaks through its sealed interfaces with the pump assembly 30 and housing 10. In some embodiments, the cartridge 40 may incorporate mechanical keying features that indicate cartridge type, scent family, or compatibility to the user or to the diffuser system.

### Pump Mechanism

Referring to FIGS. 1-3, the pump assembly 30 comprises a pump mechanism 56 configured to draw liquid fragrance 48 from the cartridge reservoir 46 and dispense it toward the diffusion medium 20 upon manual actuation by the user. The pump mechanism 56 is a manually-actuated, non-electronic mechanism that requires no electrical power or battery. The pump assembly 30 includes a pump head 32, a pump stem 34, and a dip tube 36 that extends downward into the cartridge reservoir 46.

In the preferred embodiment, the pump mechanism 56 is a push-down liquid dispenser. When the user depresses the actuation button 14, force is transmitted to the pump head 32 (as described below under Force Transmission System), compressing an internal spring and actuating a valve system within the pump mechanism 56. This draws liquid fragrance 48 from the reservoir 46 through the dip tube 36 and dispenses it upward through the pump stem 34 to a pump output area 58 (also referred to herein as the output region) positioned at or near the top of the pump assembly 30. Upon release of the actuation button 14, the internal spring returns the pump mechanism 56 to its resting position and the valve system resets for the next actuation cycle.

In some embodiments, the pump mechanism 56 is based on push-down dispensers commonly used in cosmetic or manicure applications, wherein liquid pools in a dish or reservoir at the top of the pump stem 34 upon actuation. The dish may have a single central outlet or multiple outlets, pores, or apertures through which liquid emerges. The present disclosure adapts this general type of mechanism for fragrance delivery by configuring the pump output area 58 to interface directly with the absorbent diffusion medium 20, rather than providing an open dish for manual access as in the conventional cosmetic application.

The pump mechanism 56 may be an off-the-shelf component adapted for this application or a custom-designed mechanism optimized for fragrance oil viscosity and controlled metering. In an exemplary embodiment, each actuation dispenses approximately 0.1 mL of liquid fragrance. The user may press the actuation button 14 multiple times to deliver additional liquid fragrance to the diffusion medium 20, thereby adjusting fragrance strength and duration according to user preference.

### Diffusion Medium

Referring to FIGS. 2-3, the diffusion medium 20 is a replaceable absorbent element designed to receive, retain, and gradually release fragrance into the surrounding air. In the preferred embodiment, the diffusion medium 20 is configured as a generally cylindrical sleeve that fits around the pump output area 58 and resides within the housing 10. The diffusion medium 20 may have a hollow core 22 extending along its longitudinal axis to accommodate force transmission components and/or to fit around the pump stem 34 or pump output structure.

The diffusion medium 20 may be constructed from cellulose, ceramic, pressed paperboard, cotton, rattan, synthetic fibers such as polyester or polyethylene, or combinations thereof. The medium 20 is selected to absorb and release fragrance liquid effectively and gradually, resisting clogging or degradation with repeated use cycles.

The diffusion medium 20 may incorporate surface features that increase surface area for enhanced evaporation and fragrance release. These features may include vertical channels, ridges, grooves, gear-like cuts, lattice patterns, or textured surfaces formed on the exterior of the medium 20. In some embodiments, the medium 20 includes internal channels or passages that direct airflow from one side to the other, further enhancing diffusion efficiency. In the assembled configuration, the outer surface of the diffusion medium 20 is spaced inward from the interior wall of the housing 10, defining an annular gap therebetween that permits air to circulate around the medium 20. The airflow apertures 12 in the housing 10 are positioned to promote air circulation through the apertures, across and around the diffusion medium 20, and out through opposing apertures, so that ambient air or forced air from a vehicle vent carries fragrance vapor away from the medium surface and out of the housing 10.

The diffusion medium 20 remains separated from the liquid fragrance 48 in the cartridge 40 except when fragrance is transferred via the pump mechanism 56. Unlike some prior art air freshener designs in which an absorbent element is in constant contact with a liquid fragrance reservoir, the medium 20 of the present disclosure receives liquid only on demand when the user actuates the pump. This separation provides multiple advantages: the fragrance lasts longer because the evaporation rate is controlled by the amount dispensed rather than by continuous wicking from a reservoir; the medium 20 is not prematurely saturated with non-volatile components; and the risk of liquid fragrance escaping the diffuser and damaging vehicle interiors is significantly reduced.

The diffusion medium 20 is designed for regular replacement. Over time and repeated use, the medium 20 may accumulate non-volatile residues from the fragrance liquid or gradually degrade in absorption capacity. At that point, the user replaces the medium 20 with a fresh element. When changing fragrance scents, the user may replace both the cartridge 40 and the diffusion medium 20 to prevent scent mixing from residual fragrance in the old medium.

### Direct Interface—Pump to Medium

A distinguishing feature of the present disclosure is the direct interface between the pump output area 58 and the diffusion medium 20. Referring to FIG. 3, in the preferred embodiment, the diffusion medium 20 fits snugly around the pump output area 58, creating a direct contact interface wherein dispensed liquid fragrance is immediately absorbed by the medium 20 upon actuation. The medium 20 may be sized and shaped to create a friction fit or slight compression against the pump head 32, ensuring intimate contact for liquid transfer and retaining the medium 20 in position on the pump assembly 30 during normal use and handling. The absence of an open dish or accessible reservoir eliminates pooling of liquid fragrance and reduces leak potential across all orientations of the diffuser. As used herein, the phrase “directly to” the absorbent diffusion medium encompasses delivery both “directly onto” an exposed surface of the medium and “directly into” the body of the medium, such as through embedded tubes or channels.

In a single-outlet configuration, the pump mechanism 56 has one central outlet at the pump output area 58. Liquid fragrance dispensed from this single outlet is absorbed at the point of contact with the diffusion medium 20 and subsequently distributes throughout the medium 20 by capillary wicking action. The natural wicking properties of the absorbent medium material draw the liquid radially outward and along the length of the medium 20 from the point of initial contact, gradually saturating a larger volume of the medium 20 over the seconds and minutes following actuation.

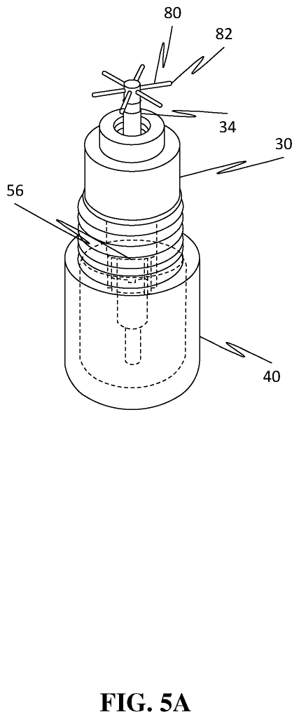

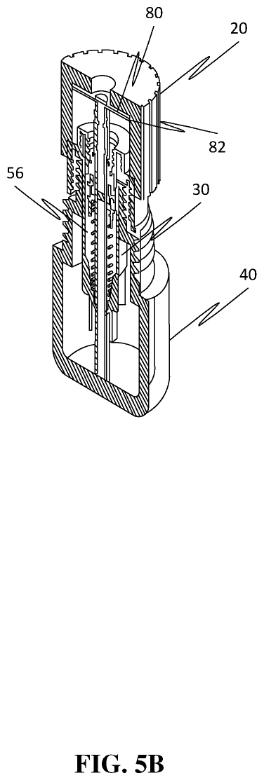

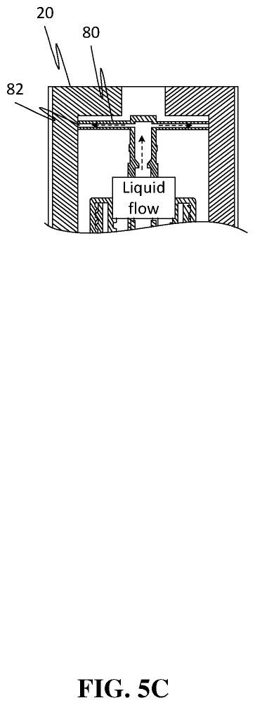

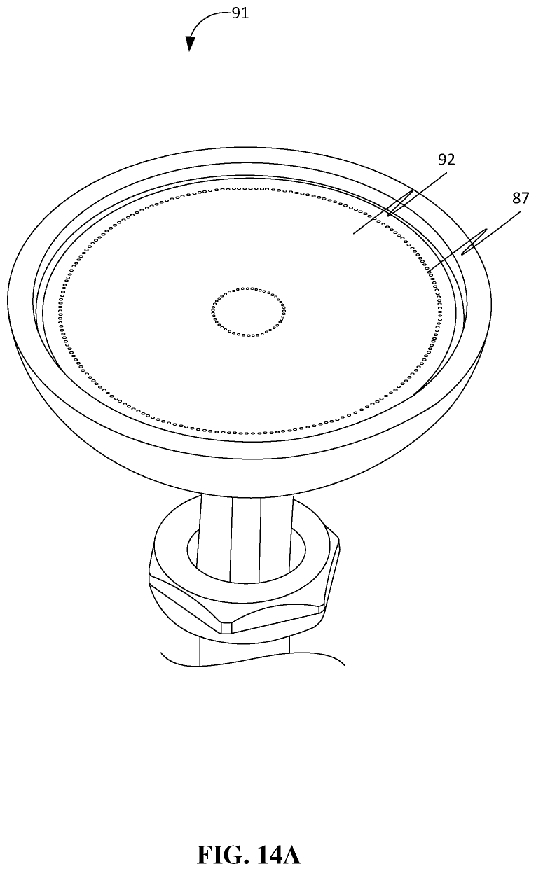

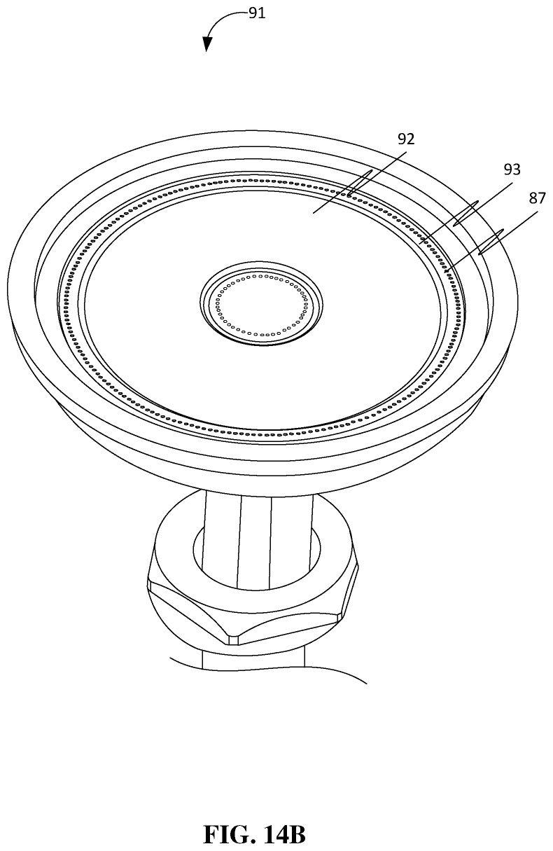

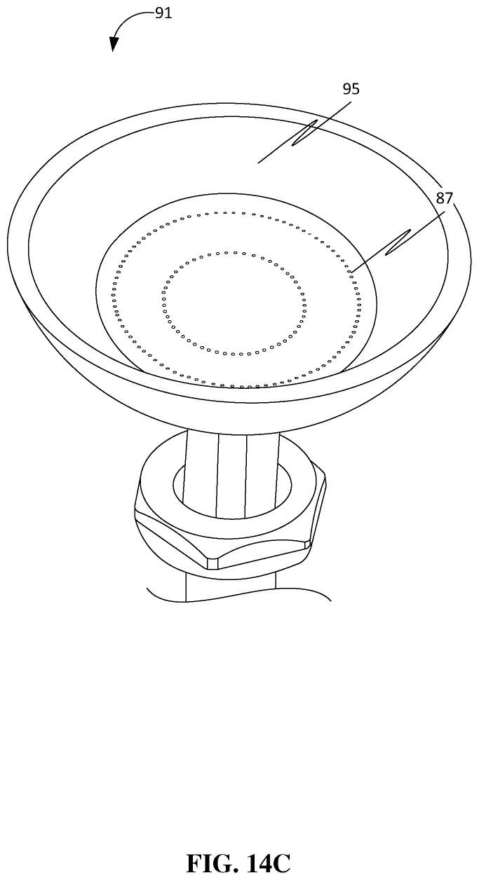

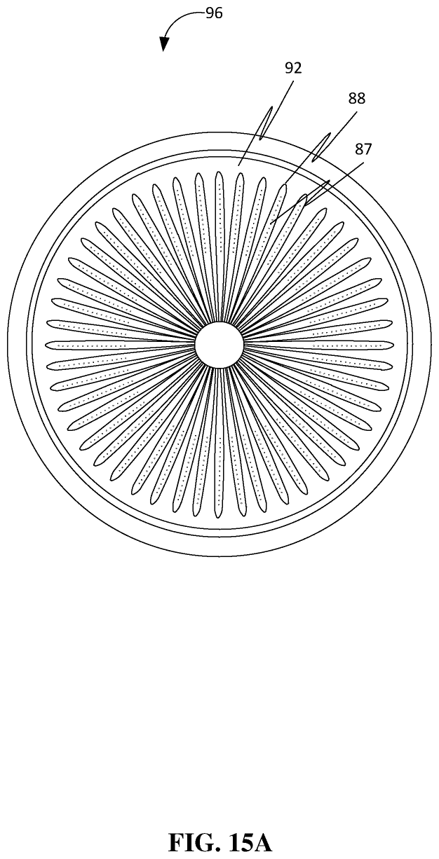

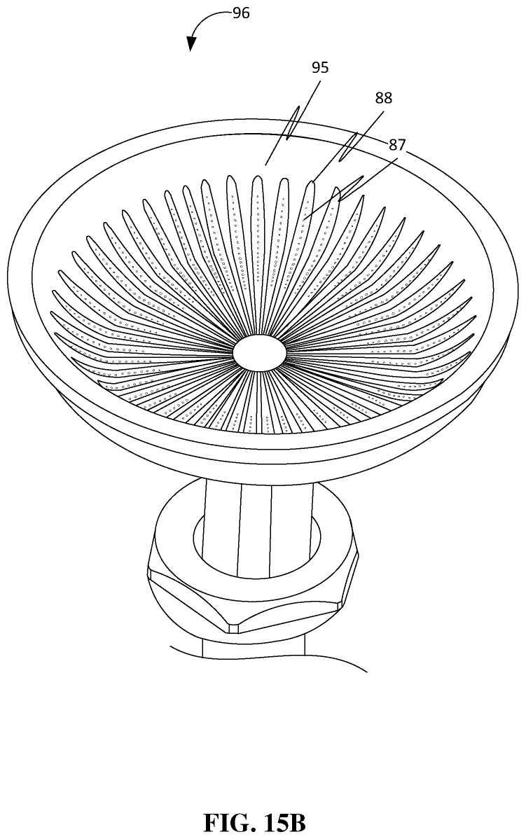

Alternative configurations for distributing liquid fragrance from the pump to spatially separated locations within the diffusion medium 20—including radial tube delivery, multi-aperture dish elements, channel structures, and holding chambers—are described below in connection with FIGS. 5A-5C, 13, 14A-14C, and 15A-15B. FIG. 14A is a top perspective view of a dish element 91 with a flat top surface 92 comprising the plurality of apertures 87, in accordance with some embodiments. FIG. 14B is a top perspective view of the dish element 91 with the flat top surface 92 comprising a plurality of channels 88 and the plurality of apertures 87, in accordance with some embodiments. FIG. 14C is a top perspective view of the dish element 91 with a recessed top surface 95 comprising the plurality of apertures 87, in accordance with some embodiments. FIG. 15A is a top view of a dish element 96 with a flat top surface 92 comprising a plurality of apertures 87 and a plurality of channels 88, in accordance with some embodiments. FIG. 15B is a top perspective view of the dish element 96 with a recessed top surface 95 comprising the plurality of apertures 87 and the plurality of channels 88, in accordance with some embodiments.

### Force Transmission System

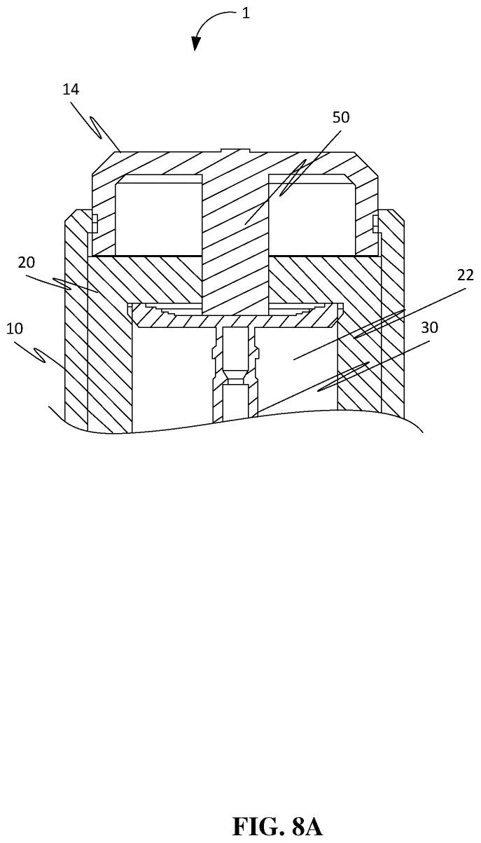

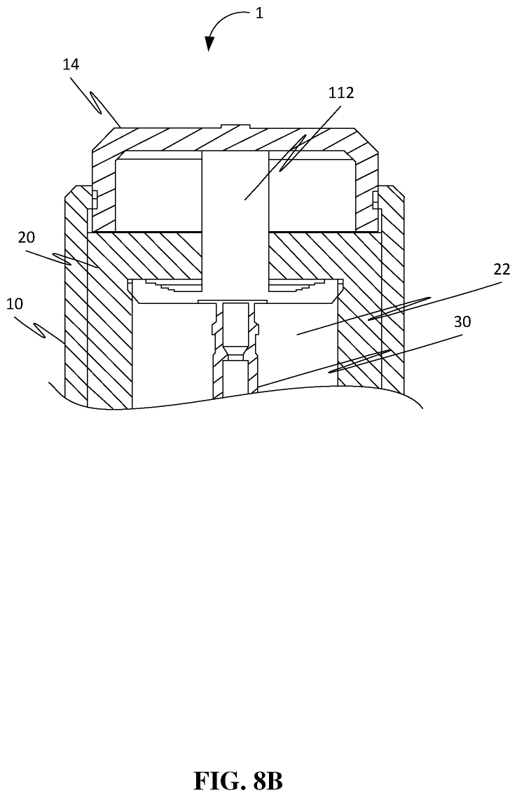

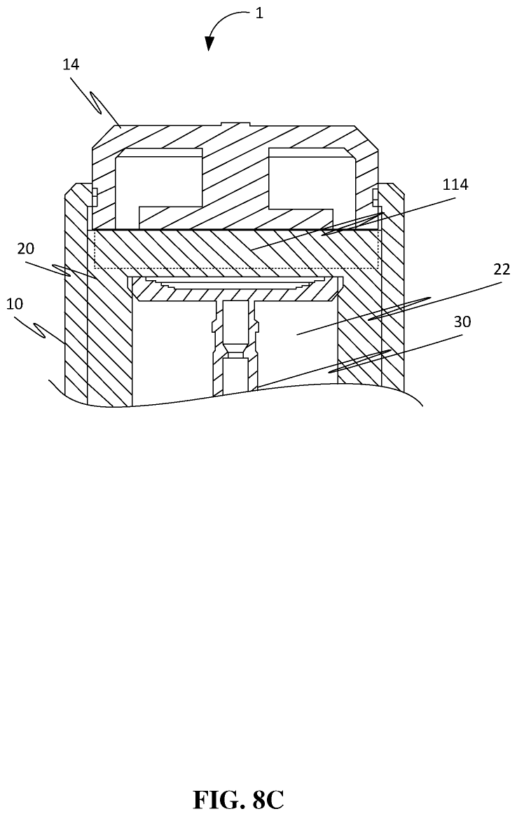

A key design consideration of the present disclosure is the transmission of actuation force from the actuation button 14 (or more generally, the actuation element) at the top of the housing 10 to the pump mechanism 56, given that the diffusion medium 20 is positioned between the button 14 and the pump head 32 in the assembled configuration (see FIG. 3). The invention contemplates multiple force transmission configurations, each of which is described below. The structural component that transmits force is referred to herein as a force transmission element or, equivalently, a force transmission member; both terms describe the same functional category and are used interchangeably throughout this description. The force transmission configurations are illustrated schematically in FIGS. 8A-8C.

### First Embodiment—Plunger Through Hollow Core

In each of the following configurations, the actuation element (button 14) is positioned at a first end of the diffuser, and the pump mechanism 56 is positioned at a second end of the diffuser opposite the first end, with the diffusion medium 20 positioned between them. The force transmission element or member bridges this distance to transmit the actuation force from the first end to the second end.

Referring to FIGS. 3 and 8A, in the preferred embodiment, a force transmission element 50 (force transmission member) in the form of an elongate member, such as a plunger or rod, extends from the actuation button 14 downward through the hollow core 22 of the diffusion medium 20, directly engaging the pump head 32. The diffusion medium 20 in this configuration has an annular or tubular form with the central void defined by the hollow core 22. Upon depression of the actuation button 14, the plunger 50 travels downward through the hollow core 22 and presses on the pump head 32, compressing the internal spring of the pump mechanism 56 and actuating the valve system to dispense liquid fragrance.

The hollow core 22 is sized to allow free vertical travel of the plunger 50 without significant friction against the inner wall of the medium 20. In some embodiments, a small clearance gap exists between the plunger 50 and the inner surface of the hollow core 22. In other embodiments, the plunger 50 may lightly contact the inner surface of the hollow core 22, with the contact area being minimal so as not to impede actuation travel.

### Second Embodiment—Integrated Pump Extension

Referring to FIG. 8B, in a second embodiment, the force transmission member is integrated into the pump assembly 30 and extends upward from the pump head 32. In this configuration, the pump assembly 30 includes an extension 112, stem, or post that protrudes upward through the hollow core 22 of the diffusion medium 20 and contacts the underside of the actuation button 14. When the user presses the actuation button 14, force is transmitted downward through this integrated extension 112 to actuate the pump mechanism 56.

This configuration differs from the first embodiment in that the force transmission member is part of the pump assembly 30 rather than being a separate component attached to or extending from the actuation button 14. The functional result is equivalent—actuation force travels through the hollow core 22 of the annular diffusion medium 20 to reach the pump mechanism 56—but the component integration may offer manufacturing or assembly advantages.

### Third Embodiment—Medium As Force Transmitter

Referring to FIG. 8C, in a third embodiment, the diffusion medium 20 itself serves as the force transmission member and transmits the actuation force. In this configuration, the medium 20 is constructed of a material or structure with sufficient rigidity to transfer compressive force from the actuation button 14 to the pump head 32. The actuation button 14 is pressed on the top surface of the medium 20, which in turn presses on the pump head 32. The medium 20 may incorporate a rigid or semi-rigid core section 114 to facilitate force transmission while maintaining absorbent properties in its outer regions. Further, a rigidity of the core section 114 is greater than the rigidity of the medium 20. Further, the core section 114 is comprised in a top portion of the medium to interface with the actuation button. Further, the core section 114 interfaces with the actuation button 14 upon pressing the actuation button 14. This embodiment eliminates the need for a separate plunger or extension, and the medium 20 need not have a hollow core 22. Further, in some embodiments, the medium 20 is comprised of viscoelastic polyurethane foam. Further, the medium 20 compresses when the actuation button 14 is pressed on the top surface of the medium, and receives the liquid fragrance in a compressed state. Further, the medium 20 recovers from the compressed state after the actuation and/or upon completion of the actuation. Further, the recovery of the medium 20 is delayed and/or not immediate based on the medium 20 comprising the viscoelastic polyurethane foam. Further, in an embodiment, the medium 20 comprises a compressible hydrophilic open-cell reticulated polyurethane foam, the medium 20 being transitionable between a compressed state in which the medium 20 receives the liquid fragrance from the dispensing assembly (i.e., pump assembly 30) by capillary uptake and an expanded state in which the medium 20 permits airflow therethrough to facilitate evaporation of the liquid fragrance. Further, in an embodiment, the medium 20 includes a composite of a first porous polymeric material and a second hydrophilic absorbent material, the first porous polymeric material providing airflow passages in an expanded state of the medium 20, and the second hydrophilic absorbent material receiving the liquid fragrance from the dispensing assembly in a compressed state of the medium 20.

The structural rigidity required for force transmission may be achieved through material selection (e.g., a denser or stiffer absorbent material), geometric design (e.g., a thicker or more compact form), or a composite construction where a rigid inner core is surrounded by or embedded within an absorbent outer material. The compressive displacement required to actuate the pump mechanism 56 is typically small—on the order of a few millimeters—and the medium 20 needs only to be sufficiently rigid to transmit this limited displacement without collapsing or absorbing the force.

### Fourth Embodiment—External Force Transmission Path

In a further embodiment, the force transmission member extends around the exterior of the diffusion medium 20 rather than through an internal channel. In this configuration, one or more rods, linkages, or structural elements are routed along the outside surface of the medium 20, connecting the actuation button 14 to the pump head 32. The external force transmission path may pass through corresponding channels or recesses in the inner wall of the housing 10, or may be positioned in the annular gap between the medium 20 and the housing wall. This configuration permits the use of a solid diffusion medium 20 without a hollow core, while maintaining the spatial arrangement of the actuation element at the first end and the pump mechanism at the second end with the medium between them.

### Basic Operation

In use, the fragrance diffuser is assembled by inserting the diffusion medium 20 over the pump assembly 30, connecting the pump assembly 30 to the cartridge 40 (if not already connected as a pre-assembled unit), and securing the pump-cartridge-medium assembly into the housing 10. The assembled diffuser is then mounted to a vehicle air vent using the vent clip 60 or other mounting accessory.

To release fragrance, the user presses the actuation button 14. Force is transmitted through the force transmission element 50 (or equivalent force transmission member) to the pump head 32, actuating the pump mechanism 56. The pump mechanism 56 draws liquid fragrance 48 from the cartridge reservoir 46 through the dip tube 36 and dispenses it to the diffusion medium 20 at the pump output area 58. The diffusion medium 20 absorbs the liquid, and the increased surface area of the medium—enhanced by features such as gear-like cuts, channels, or textured surfaces—promotes natural evaporation into the air. Air circulating through the housing 10 via the airflow apertures 12 carries fragrance vapor outward into the surrounding environment.

The user may press the actuation button 14 multiple times to adjust the fragrance strength and duration, saturating the diffusion medium 20 to the desired level. When the fragrance fades—whether after minutes or hours depending on the amount dispensed, ambient temperature, and airflow conditions—the user simply presses the button 14 again to refresh the scent. Once the cartridge 40 is depleted, it can be replaced, along with the diffusion medium 20, if the medium is saturated, degraded, or if the user wishes to change fragrance scents. The replacement sequence is described in detail in connection with FIG. 3.

The dispensing mechanism provides satisfying tactile feedback through its press-and-release action. In some embodiments, the actuation produces a soft misting sound—a subtle hiss or spray noise—that provides audible confirmation of fragrance delivery to the user.

### Liquid Distribution Structures—Overview

As described above in connection with FIG. 3, the preferred embodiment employs a direct interface wherein the diffusion medium 20 contacts the pump output area 58 and liquid fragrance dispensed from a single outlet is distributed through the medium 20 by capillary wicking action. In alternative embodiments, the pump mechanism 56 includes a liquid distribution structure configured to deliver liquid fragrance to a plurality of spatially separated locations within the absorbent diffusion medium 20, rather than relying solely on wicking from a single contact point. The liquid distribution structure improves the uniformity and speed of fragrance saturation across the medium 20, which may be particularly advantageous for larger-diameter or denser medium configurations where capillary wicking from a single point may be insufficient to achieve uniform distribution within a desired time.

The liquid distribution structure may take several forms, each of which is described below. These configurations may be used individually or in combination; for example, radial tubes may be used together with a dish element, or holding chambers may be added to any of the other configurations to provide excess-capacity buffering. In each case, the liquid distribution structure is integrated with or attached to the pump assembly 30 and is positioned to interface with the diffusion medium 20 so that liquid fragrance dispensed by the pump mechanism 56 is delivered into the body of the medium 20 at multiple points.

### Radial Tube Delivery System

Referring to FIGS. 5A-5C, in one embodiment, the liquid distribution structure comprises a plurality of radial tubes 80 (also referred to as nozzles) extending outward from the pump stem 34, perpendicular or approximately perpendicular to the longitudinal axis of the diffuser. The radial tubes 80 are in fluid communication with the pump mechanism 56 such that, upon actuation, liquid fragrance travels upward through the pump stem 34 and is directed outward through the radial tubes 80. Each radial tube 80 terminates at a tube outlet 82 positioned within an interior region of the absorbent diffusion medium 20.

Referring to FIG. 5A, the radial tubes 80 extend outward from the pump stem 34 like spokes of a wheel. In the illustrated embodiment, the pump-cartridge assembly is shown with the radial tubes 80 visible above the pump head 32. The number of radial tubes 80 may vary; embodiments with three, four, six, or more tubes are contemplated. The tubes 80 may be evenly spaced circumferentially around the pump stem 34, or may be arranged in a non-uniform pattern to accommodate the geometry of a particular diffusion medium configuration.

Referring to FIGS. 5B and 5C, the radial tubes 80 penetrate into the body of the diffusion medium 20 when the medium is installed around the pump assembly 30. Liquid fragrance 48 travels through the radial tubes 80 in the direction indicated by arrows in FIGS. 5B and 5C and emerges at the tube outlets 82, which are embedded within the interior of the medium 20. This configuration distributes liquid more evenly throughout the medium 20 compared to a single-outlet configuration, and reduces reliance on wicking action from a central point. The radial tubes 80 constitute a branching distribution structure in that a single liquid input from the pump stem 34 is divided and directed to a plurality of spatially separated outlet locations within the medium 20.

The radial tubes 80 may be integrally formed with the pump assembly 30 (e.g., molded as part of the pump head or stem structure) or may be a separate component that attaches to the pump assembly 30. The inner diameter of the radial tubes 80 may be selected to meter liquid flow and to ensure adequate liquid delivery to each outlet 82 during a single pump actuation. In some embodiments, the radial tubes 80 have a uniform inner diameter along their length. In other embodiments, the radial tubes 80 may taper or flare toward the outlets 82. In further embodiments, the radial tubes 80 include one or more apertures or pores along their length, in addition to or instead of a terminal outlet 82, so that liquid fragrance emerges at multiple points distributed along the tube and is absorbed by the surrounding diffusion medium 20 over a larger contact area. In some embodiments, the radial tubes 80 are embedded within or supported by a disc or platform structure positioned at the pump output area 58. In such configurations, the force transmission element 50 or force transmission member may press on the upper surface of the disc structure to actuate the pump mechanism 56, with the disc transmitting actuation force to the pump head 32 while simultaneously providing structural support for the radial tubes 80. This arrangement permits the liquid distribution and force transmission functions to share common structural components.

### Modified Dish With Apertures

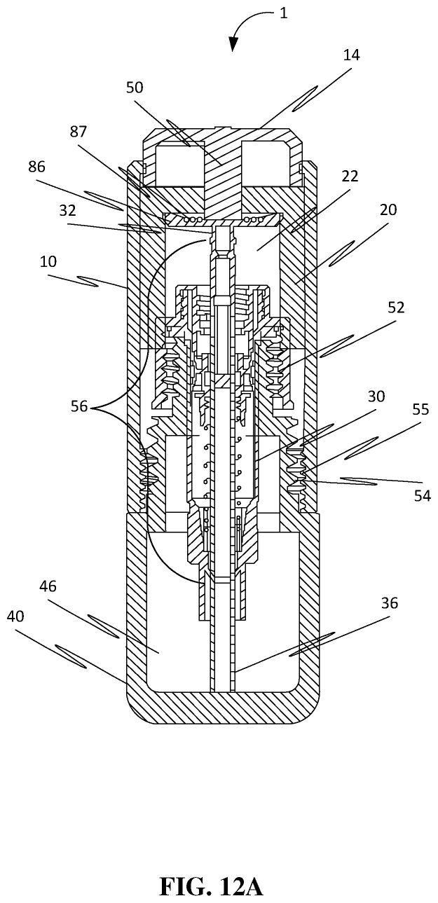

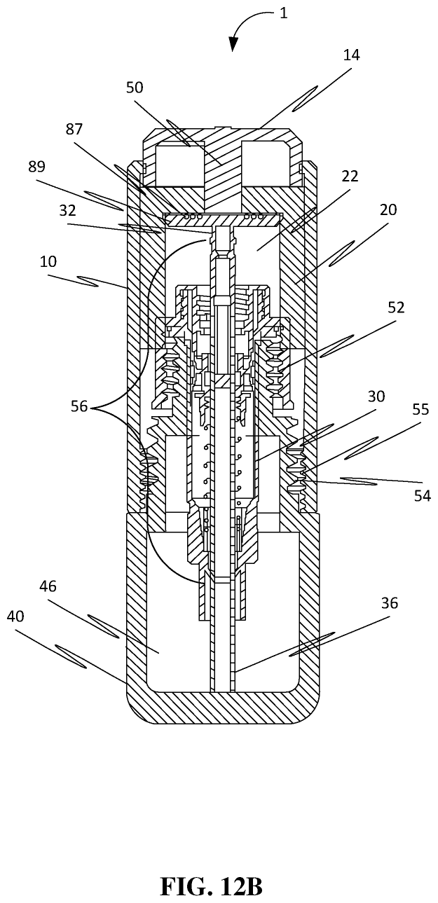

Referring to FIG. 12A, in another embodiment, the liquid distribution structure comprises a dish element 86 positioned at the pump output area 58. The dish element 86 has a plurality of apertures 87 through which liquid fragrance emerges upon actuation of the pump mechanism 56. When liquid fragrance is dispensed by the pump, it enters the dish element 86 and distributes across its surface before emerging through the apertures 87. The diffusion medium 20 is positioned in contact with or immediately adjacent to the outer surface of the dish element 86, such that liquid emerging through the apertures 87 is absorbed by the medium 20 at a plurality of spatially separated points corresponding to the locations of the apertures 87.

The apertures 87 may be arranged in a regular pattern (e.g., a grid or concentric rings) or in an irregular pattern optimized for the geometry of the particular diffusion medium 20. The size and number of apertures 87 may be selected to control the rate of liquid delivery and the distribution pattern. Smaller and more numerous apertures 87 promote finer distribution of liquid across a larger contact area with the medium 20.

Referring to FIG. 12B, in another embodiment, the liquid distribution structure comprises a dish element 89 positioned at the pump output area 58. The dish element 89 has a plurality of apertures 87 through which liquid fragrance emerges upon actuation of the pump mechanism 56.

### Channel and Groove Configuration

In another embodiment, the liquid distribution structure (such as the dish element 86 and dish element 89, as shown in FIGS. 12A-12B) comprises channels or grooves 88 configured to direct liquid fragrance radially outward from a central dispensing point into the diffusion medium 20. In the illustrated embodiment, the channels 88 are formed on the upper surface of a modified dish or platform at the pump output area 58 and extend radially from the center toward the periphery. Upon actuation, liquid fragrance is dispensed at the central point and flows outward through the channels 88 by a combination of the dispensing pressure and capillary action within the channel geometry.

The channels 88 may be open grooves, closed capillary channels, or a combination thereof. The cross-sectional profile of the channels 88 may be V-shaped, U-shaped, rectangular, or semicircular. In some embodiments, the channels 88 are formed on a surface that contacts the diffusion medium 20, so that liquid within the channels 88 is wicked into the medium 20 along the entire length of each channel 88, not just at the channel terminus. This provides a distributed absorption interface that is elongated rather than point-based.

The channel configuration may be used in conjunction with the dish element 86 described above; for example, the dish element 86 may include both apertures 87 and channels 88 on its upper surface to provide multiple complementary distribution pathways.

### Holding Chamber Configuration

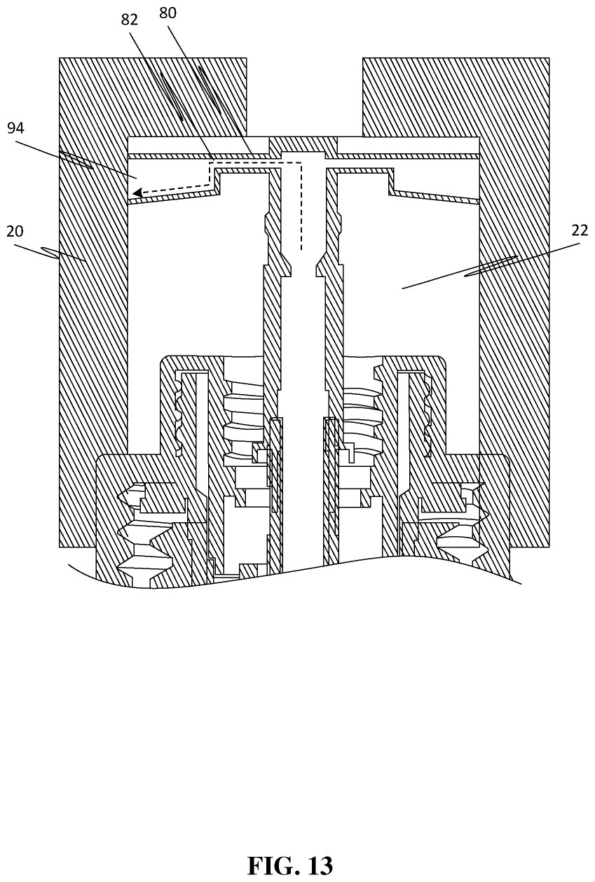

Referring to FIG. 13, in a further embodiment, the liquid distribution structure includes one or more holding chambers 94 positioned at the outlets of the radial tubes 80 or other distribution elements. The holding chambers 94 are expanded volumes—relative to the tube or channel cross-section that feeds them—configured to temporarily retain liquid fragrance in excess of the diffusion medium's immediate absorption capacity. Each holding chamber 94 has sufficient volume to accommodate liquid dispensed during a single actuation (or multiple actuations) that exceeds the rate at which the surrounding medium 20 can absorb it.

As the diffusion medium 20 becomes less saturated through evaporation over time, capillary action draws liquid fragrance from the holding chambers 94 into the surrounding medium 20, as indicated by arrows in FIG. 13. This capillary-driven transfer continues until the holding chambers 94 are depleted or until equilibrium is reached between the liquid in the chambers and the saturation level of the medium 20. The holding chambers 94 thereby function as local reservoirs that extend the effective delivery period of a single actuation event, smoothing the release of fragrance over a longer duration.

Additionally, changes in diffuser orientation—for example, when a vehicle turns or the diffuser is repositioned—may cause liquid in the holding chambers 94 to flow by gravity into different regions of the medium 20, further promoting even distribution throughout the medium.

The holding chambers 94 may take various forms, including expanded bulb-shaped volumes at the termini of the radial tubes 80, annular reservoirs surrounding the pump output area 58, or distributed pockets embedded at various locations within or adjacent to the medium 20. The holding chambers 94 may be integrally formed with the radial tubes 80, with the dish element 86, or as a separate structural component of the pump assembly 30.

### Modular System Architecture—Operational Overview

As described above in connection with FIGS. 1-3, the fragrance cartridge 40 has a first neck 42 and a second neck 44, wherein the pump assembly 30 attaches to the first neck 42 and the housing 10 (also referred to as the diffuser shell) attaches to the second neck 44. The pump assembly 30 and cartridge 40 thereby form a pump-cartridge subassembly that functions as a self-contained dispensing unit. The absorbent diffusion medium 20 is positioned around or adjacent to the output region of the pump assembly 30, and rides with the pump-cartridge subassembly when the subassembly is removed from the housing 10.

This modular architecture provides three levels of user serviceability, each of which can be performed without requiring tools. First, the user can remove the entire pump-cartridge subassembly (with diffusion medium 20 attached) from the housing 10 by disengaging the second neck 44 from the housing's attachment interface 55. Second, with the subassembly removed, the user can replace the diffusion medium 20 independently of the cartridge 40 by sliding the medium off the pump assembly 30. Third, the user can detach the pump assembly 30 from the first neck 42 of the cartridge 40 and transfer the pump to a new cartridge.

The housing 10 has a plurality of airflow perforations 12 and an attachment interface 55 at its lower end. In the preferred embodiment, the attachment interface 55 comprises threads. The pump-cartridge subassembly is removably attachable to the housing 10 via engagement between the second neck 44 and the attachment interface 55. This engagement provides secure retention during normal use while permitting disassembly by the user when maintenance is required.

### Disassembly and Replacement Sequence

FIG. 1 shows the diffuser in its assembled configuration, with the housing 10 enclosing the internal components. In the illustrated embodiment, the cartridge 40 is constructed of transparent material such that the liquid fragrance level is observable through the cartridge wall. In this state, the user determines that the cartridge 40 is depleted (observable through the transparent cartridge wall), that routine replacement of the diffusion medium 20 is due, or that a fragrance change is desired.

In a first disassembly step, the pump-cartridge subassembly, together with the diffusion medium 20, is separated from the housing 10. In the preferred embodiment, the user unscrews the subassembly from the housing 10 by rotating the cartridge 40 relative to the housing 10, disengaging the threaded engagement between the second neck 44 and the housing attachment interface 55. The pump-cartridge subassembly and diffusion medium 20 are thereby removable from the shell as a unit. In alternative embodiments employing snap-fit, bayonet twist-lock, or friction-fit interfaces, the user performs the corresponding disengagement action (pulling, twisting, or sliding) to separate the subassembly from the housing 10.

In a second disassembly step, the diffusion medium 20 is removed from the pump assembly 30. In the preferred embodiment, the diffusion medium 20 is configured as a sleeve that slides over the pump assembly output region, and the medium 20 is removable by sliding the sleeve upward off the pump assembly 30. The sleeve is sized to create a snug friction fit around the pump output area 58, which retains the medium 20 in position on the pump assembly 30 during normal use and handling. This friction fit is sufficient to prevent inadvertent dislodging, yet can be readily overcome by the user's hand when replacement is desired. In the assembled configuration, the outer surface of the diffusion medium 20 is spaced inward from the interior wall of the housing 10, leaving a gap therebetween. This gap permits airflow to circulate through the airflow apertures 12, around and across the exterior surface of the medium 20, and out through opposing apertures, promoting evaporation and fragrance dispersion. The user discards the used diffusion medium 20.

The third disassembly step is performed when the cartridge 40 is also being replaced: the pump assembly 30 is detached from the depleted cartridge 40 by disengaging the first neck 42 from the pump assembly 30. In the preferred embodiment, the user unscrews the pump assembly 30 from the first neck 42, disengaging the threaded interface 52. The pump assembly 30 is retained for reuse with the new cartridge.

Reassembly with fresh components: the pump assembly 30 is attached to a new, full fragrance cartridge 40 by engaging the pump assembly 30 with the first neck 42 of the new cartridge. A new diffusion medium 20 is installed by sliding it downward over the pump assembly 30 until it seats around the pump output area 58. In the preferred embodiment, the medium 20 slides over the pump stem 34 and any associated structures (such as radial tubes 80 or a disc structure, if present) and comes to rest in contact with or immediately adjacent to the pump output area 58.

In a completed reassembly step, the pump-cartridge-medium assembly is reinstalled into the housing 10 by engaging the second neck 44 with the housing attachment interface 55. The diffuser is now ready for use with the new cartridge and fresh diffusion medium.

### Replacement Scenarios

The modular architecture supports several replacement scenarios depending on the user's needs. To replace only the diffusion medium 20—for example, when the medium is degraded, but the cartridge still contains liquid fragrance—the user performs the steps to remove the medium, installs a new medium, and reassembles, skipping the cartridge replacement step. To replace only the cartridge 40—for example, to switch to a different fragrance—the user may also wish to replace the diffusion medium 20 simultaneously to prevent scent mixing from residual fragrance in the old medium. In that case, the user performs the full sequence of steps.

In some embodiments, the cartridge 40 is refillable rather than disposable. To refill a depleted cartridge, the user separates the pump assembly 30 from the cartridge 40, fills the cartridge reservoir 46 with liquid fragrance of the user's choice (e.g., using a dropper or pour spout), and reattaches the pump assembly 30. The refillable cartridge may include a removable cap, septum, or other closure at the first neck 42 or at a separate fill port to facilitate refilling.

### Method of Use

In operation, the method of refreshing fragrance in an enclosed space using the diffuser of the present disclosure comprises: providing a fragrance diffuser having a housing 10, a reservoir 46 of liquid fragrance 48, a manually-actuated pump mechanism 56, and an absorbent diffusion medium 20; manually actuating the pump mechanism 56 by pressing the actuation button 14 to dispense a quantity of liquid fragrance; directing the dispensed liquid fragrance to the absorbent diffusion medium 20, wherein the diffusion medium 20 absorbs the liquid fragrance; permitting fragrance to evaporate from the diffusion medium 20 into surrounding air through the airflow apertures 12; and repeating the actuating step to refresh fragrance intensity as desired by the user.

The method further comprises, when the cartridge 40 is depleted or a fragrance change is desired: removing the depleted fragrance cartridge 40 from the diffuser together with the attached pump assembly 30; removing the used diffusion medium 20 from the pump assembly 30; separating the pump assembly 30 from the depleted cartridge 40; installing a fresh diffusion medium 20 onto the pump assembly 30; attaching the pump assembly 30 to a new fragrance cartridge 40; and reinstalling the pump-cartridge-medium assembly into the housing 10. The installation of the fresh diffusion medium and the attachment of the pump assembly to the new cartridge may be performed in either order.

Each of the foregoing method steps is performed by the user without requiring tools. The modular architecture of the dual-neck cartridge 40—with the pump assembly 30 attached at the first neck 42 and the housing 10 engaged at the second neck 44—ensures that the pump assembly 30 remains paired with the cartridge 40 during normal disassembly, preventing inadvertent separation of components and simplifying the maintenance process for the user.

### PREFERRED EMBODIMENT: MAGNETIC VENT-CLIP MOUNT

As introduced above in connection with FIGS. 7A-7D, the preferred mounting configuration for the fragrance diffuser employs a magnetic interface for attachment to a vent clip 60. In the preferred embodiment, the housing 10 includes a magnetic element 64 disposed on a rear surface thereof, the magnetic element 64 providing a magnetic interface on the housing 10. The vent clip 60 includes a corresponding magnetic element 66 positioned to face the magnetic element 64 when the diffuser is mounted. The magnetic elements 64 and 66 may each comprise one or more permanent magnets, or one element may be a permanent magnet and the other a ferromagnetic plate or disc, provided that the arrangement produces sufficient attractive force for secure retention. In alternative embodiments, the magnetic element 64 may be disposed on a side surface, a bottom surface, or any other external surface of the housing 10, and the corresponding magnetic element 66 on the vent clip 60 or other mount may be repositioned accordingly.

Referring to FIGS. 7A-7D, the vent clip 60 further includes a vent blade grip 68 configured to clamp onto a blade or louver of a vehicle air vent 63. The grip 68 may include a spring mechanism 62 or compressible fingers that accommodate a range of vent blade thicknesses commonly found in automotive HVAC systems. In use, the user first attaches the vent clip 60 to a desired vent blade, and then magnetically couples the diffuser to the vent clip 60 by bringing the magnetic element 64 on the housing 10 into proximity with the magnetic element 66 on the vent clip 60. The magnetic connection enables the diffuser to be attached to and detached from the vent clip 60 without tools, while providing secure retention during normal vehicle operation including vibration and moderate accelerations.

The magnetic interface provides a compact, low-profile mounting solution optimized for vehicle vent installation. Because the magnetic connection is not mechanically specific to the vent clip 60, the same magnetic element 64 on the housing 10 is compatible with any magnetically-receptive mount that positions a corresponding magnetic element in appropriate proximity. Such alternative mounts include, but are not limited to, dashboard mounts, glass mounts, hanging mounts, or any other surface incorporating a ferromagnetic or magnetic element. This universal compatibility enables the user to employ the same diffuser with different mounting accessories for different installation locations, without requiring any modification to the diffuser itself.

In the preferred embodiment, the magnetic interface is the sole physical connection between the diffuser and its mount. No mechanical interlocking, threading, or friction-fit engagement is required between the housing 10 and the vent clip 60 or other mount. This arrangement simplifies one-handed attachment and removal, which is particularly advantageous in a vehicle environment.

### ALTERNATIVE EMBODIMENT: MULTI-POSITION MOUNTING LOOP

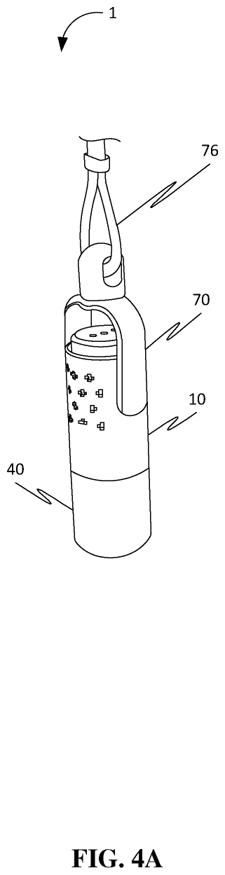

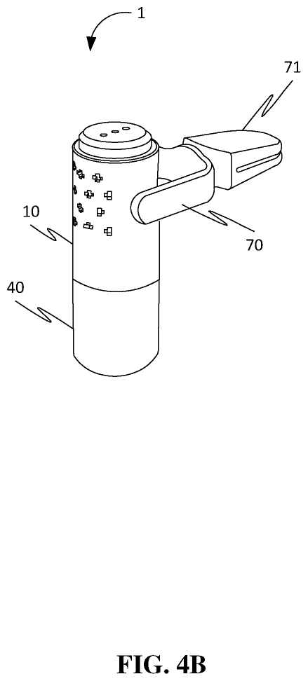

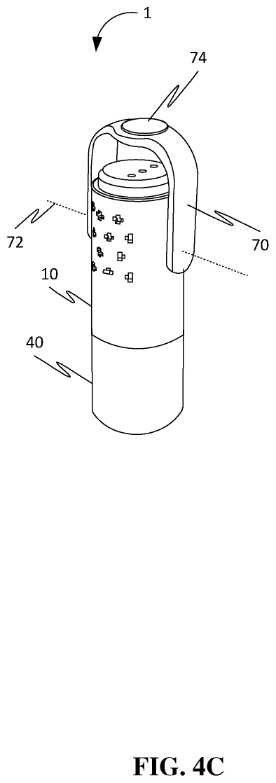

Referring now to FIGS. 4A-4C, an alternative mounting system is provided that enables the diffuser to be used in multiple mounting configurations using a single mounting element. In this alternative embodiment, the diffuser includes a loop element 70 (also referred to herein as a mounting loop) that is rotatably attached to the diffuser body (i.e., the housing 10). As used in this section, “diffuser body” refers to the housing 10 and any associated external structure to which the loop element 70 is attached; the loop element 70 is a generally ring-shaped, bail-shaped, U-shaped, V-shaped, D-shaped, rectangular, or otherwise arcuate or polygonal element via which a cord, strap, hook, or mounting accessory may be received. Further, the housing 10 is a diffuser shell.

The loop element 70 is movable between at least a first position and a second position by rotation about a rotation axis 72 (see FIG. 4C). The rotation axis 72 extends generally perpendicular to the longitudinal axis of the diffuser, passing through the pivot points where the loop element 70 is attached to the diffuser body. In the first position, illustrated in FIGS. 4A-4C, the loop element 70 extends in a generally vertical orientation (upward from the diffuser body when the diffuser is oriented with its longitudinal axis vertical). In the second position, illustrated in FIG. 4B, the loop element 70 extends in a generally horizontal orientation (laterally from the diffuser body), approximately perpendicular to its orientation in the first position.

In the first position (FIG. 4A), the loop element 70 is oriented to enable suspension of the diffuser. A strap 76, cord, or hook 71 may be threaded through or attached to the loop element 70, and the diffuser may be suspended from a vehicle rearview mirror, a hook, a knob, or any other overhead or lateral attachment point. The weight of the diffuser holds it in a generally vertical hanging orientation beneath the strap or cord attachment point.

In the second position (FIG. 4B), the loop element 70 is oriented to enable clip-based or magnetic attachment to a vehicle air vent or other surface. In this position, the loop element 70 extends laterally and may engage a vent clip or magnetic mount. The rotation of the loop element 70 from the first position to the second position thereby converts the diffuser between a hanging configuration and a clip-mounted configuration without requiring removal or replacement of any components.

The loop element 70 further includes a magnetic interface 74 that enables magnetic attachment of the loop element 70 to a magnetically-receptive surface (see FIG. 4C). The magnetic interface 74 may comprise one or more permanent magnets or ferromagnetic elements disposed within or on a surface of the loop element 70. In the second position (FIG. 4B), the magnetic interface 74 faces outward and magnetically couples with a corresponding magnetic element on a vent clip, enabling secure vent-mounted use. In the first position (FIGS. 4A-4C), the magnetic interface 74 may engage a magnetically-receptive cord, strap, hook, hanging mount, or other magnetically-receptive surface. The magnetic interface 74 thus provides attachment functionality in both the first and second positions, enhancing the versatility of the multi-position mounting system.

The rotation mechanism connecting the loop element 70 to the diffuser body may employ one or more detent positions that provide tactile feedback and positional retention at the first position and the second position. The detent positions may be implemented as spring-loaded ball detents, cam surfaces, friction-based click-stops, or similar mechanisms that resist rotation beyond a defined threshold while permitting intentional repositioning by the user. The detent positions maintain the selected orientation of the loop element 70 during use, preventing inadvertent rotation due to gravity, vibration, or incidental contact. In some embodiments, the loop element 70 may also be rotatable to one or more intermediate positions between the first position and the second position, with or without additional detent positions at such intermediate orientations.

This alternative multi-position mounting system provides versatility for users who wish to use the same diffuser unit in different vehicles or locations with different mounting preferences, or who wish to change mounting styles over time. A user whose vehicle has horizontal vent blades may deploy the diffuser in the second position (FIG. 4B) with a vent clip, while the same user may redeploy the diffuser in the first position (FIG. 4A) as a hanging air freshener in a different vehicle or non-vehicle setting. In some embodiments, a detachable mounting module separate from the diffuser core may be provided, allowing the core unit to be transferred between different mounting bases.

### ALTERNATIVE DISPENSING MECHANISM: FLIP-OVER VALVE SYSTEM

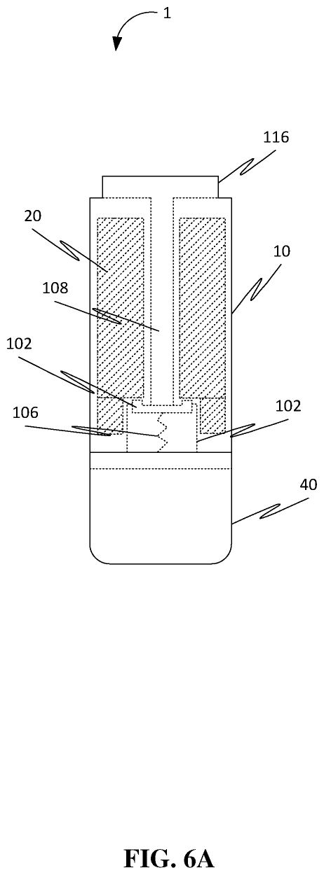

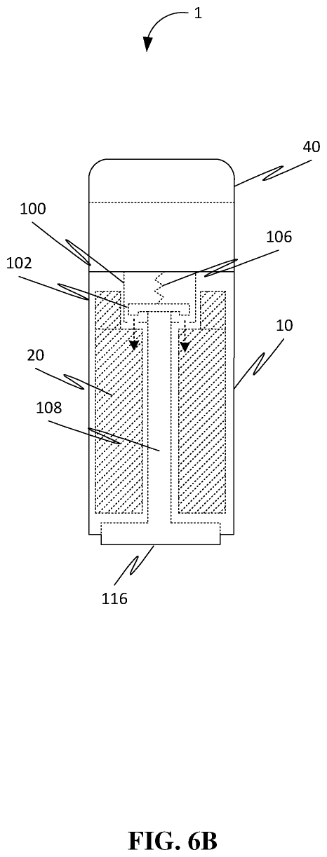

In an alternative embodiment illustrated in FIGS. 6A-6B, the manually-actuated pump mechanism described above is replaced with a gravity-fed valve-based dispensing system 100. In this configuration, the fragrance diffuser comprises a housing 10 defining an interior volume and having a plurality of airflow apertures 12; a fragrance cartridge 40 containing liquid fragrance; an absorbent diffusion medium 20 positioned within the housing 10; and the valve-based dispensing system 100 comprising one or more valves and an actuator. No pump mechanism is required.

Referring to FIG. 6A, in the upright orientation, the valve-based dispensing system 100 includes one or more valves 102 that seal the fragrance cartridge 40 in a closed position, preventing liquid fragrance from contacting the diffusion medium 20 during normal handling and transport. The valves 102 are biased toward the closed position by a spring 106 or other resilient element. An actuator (116), which may take the form of a button located at the top of the housing 10 (similar in position to the actuation button 14 of the pump-based embodiment), is connected to the valves 102 via an actuator linkage 108. In alternative embodiments, the actuator 116 may comprise one or more buttons positioned on the side of the housing 10, or a sliding, rotating, or twisting actuator. The actuator 116 may act directly on the valves 102 or may operate through a mechanical linkage.

Referring to FIG. 6B, to dispense fragrance, the user engages the actuator 116 to open the valves 102 (shown in the open position in FIG. 6B), then inverts or tilts the diffuser to allow liquid fragrance to flow by gravity from the cartridge 40, through the open valves 102, and into the absorbent diffusion medium 20 (indicated by liquid flow arrows in FIG. 6B). After the desired amount of liquid has transferred, the user returns the diffuser to its upright orientation and releases or disengages the actuator 116, allowing the spring 106 to return the valves 102 to the closed position (shown in FIG. 6A) and seal the cartridge 40.

The valves may be configured as a single central valve, multiple peripheral valves, or a combination thereof. The valve mechanism may employ elastomeric seals that return to a closed position when the actuator is released, spring-loaded closures that bias the valve toward the closed position, or membrane-based sealing. In some embodiments, the valve opening size is configured to meter the liquid flow rate, allowing the user to control the amount of fragrance dispensed by the duration for which the diffuser is held in the inverted position.

This flip-over valve configuration follows the operating principle of traditional reed diffusers and wood-cap diffusers wherein periodic inversion refreshes the diffusion medium. The valve-based dispensing system 100 adds controlled activation to this principle, preventing unintended liquid release during normal handling or transport. The valve-based embodiment offers simplicity and reduced component count compared to the pump-based system, which may be advantageous in certain cost-sensitive or simplified product configurations.

The fragrance evaporates from the diffusion medium 20 and exits the housing 10 through the airflow apertures 12 in the same manner as described above for the pump-based embodiment. The modular architecture, including the dual-neck cartridge and replaceable diffusion medium, may be employed in the valve-based embodiment as well, enabling the same user serviceability. In alternative embodiments, the valve-based system may use a single-neck cartridge or other cartridge configuration.

### Diffusion Medium—Alternative Geometries

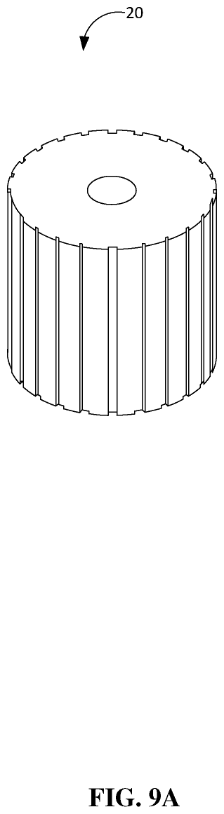

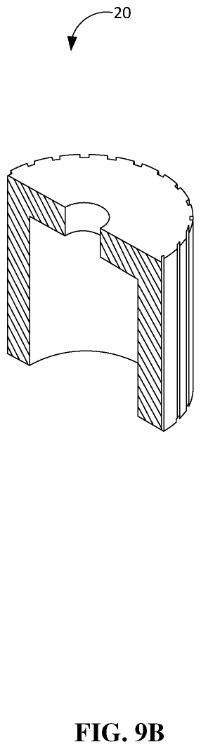

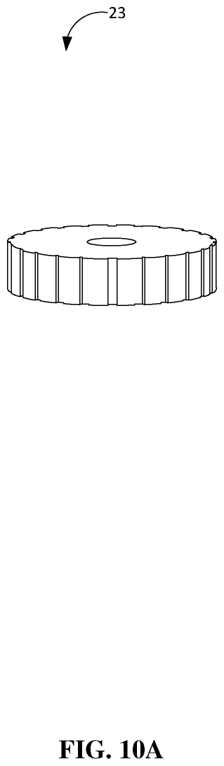

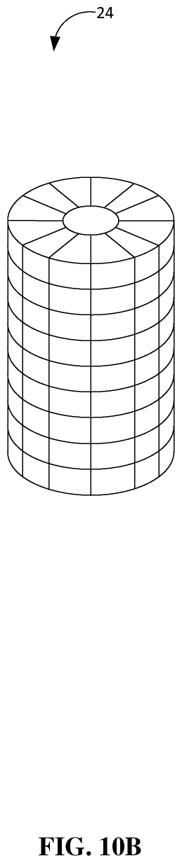

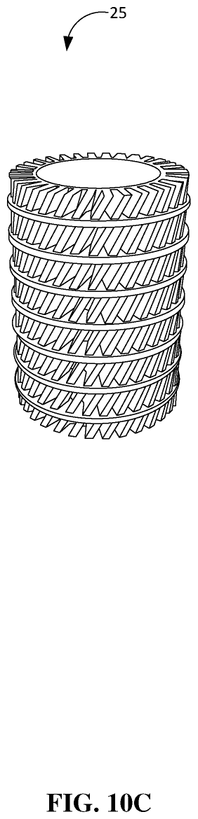

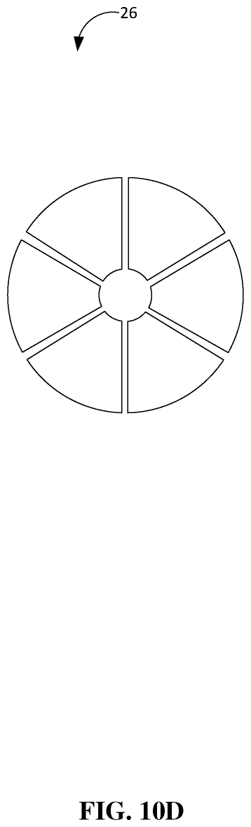

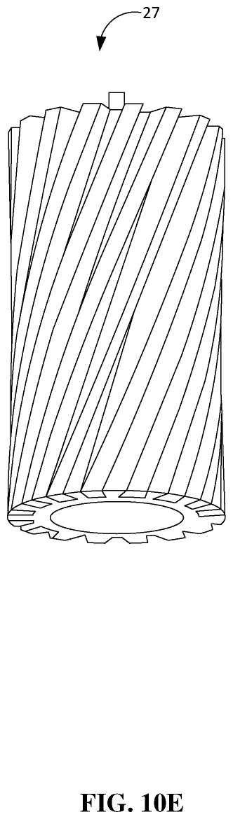

The preferred embodiment of the diffusion medium 20 is configured as a generally cylindrical sleeve with a hollow core 22. Referring now to FIGS. 9A-9B and 10A-10E, the diffusion medium 20 and alternative geometries for the diffusion medium are contemplated. FIGS. 9A-9B illustrate the preferred cylindrical sleeve configuration with hollow core for reference. FIG. 10A illustrates an annular disc configuration in which the medium has a flattened, washer-like form with a central opening, suited to embodiments where the axial length available for the medium is limited. FIGS. 10B-10C illustrate a lattice or grid structure in which the medium defines an open framework with interconnected struts or ribs, providing high surface area and enhanced airflow through the medium body. FIG. 10D illustrates a multi-element configuration in which the diffusion medium comprises a plurality of discrete absorbent elements—such as wedge-shaped segments or separate pads—arranged around the pump output area 58.

In further alternative embodiments, the diffusion medium 20 may have rectangular or square cross-sections, irregular forms optimized for specific housing configurations, or folded geometries that increase surface area within a compact volume. The medium may be a single piece or may comprise multiple discrete elements as in FIG. 10D. In embodiments using the multi-element configuration, the discrete elements may be arranged to create channels or gaps between them that promote airflow and enhance evaporation. In all configurations, the medium is designed for user replacement. The general replacement sequence follows the process described above, with the specific removal and installation steps varying according to medium geometry.

### Airflow Control Alternatives

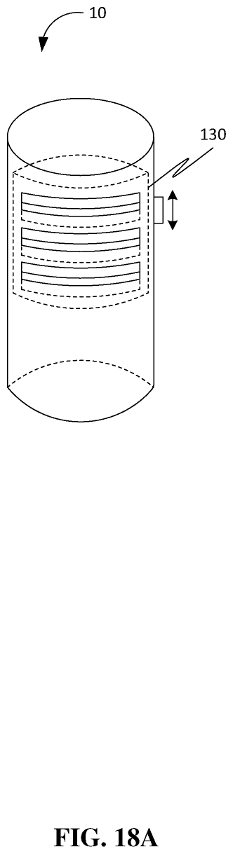

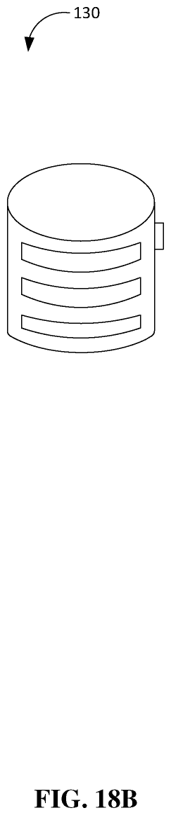

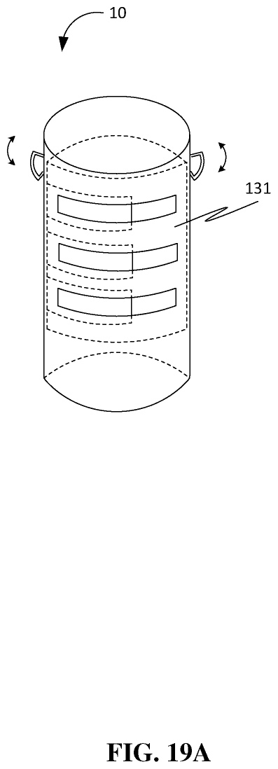

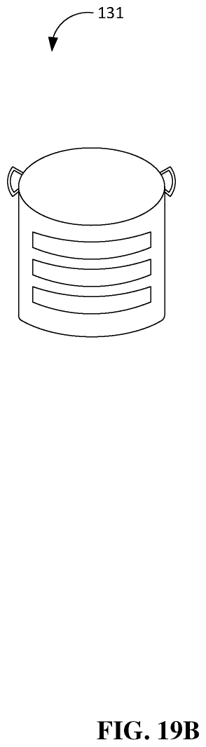

The housing 10 may incorporate airflow-modifying structures to control the rate and direction of fragrance dispersion. The rate and the direction of the fragrance dispersion are controlled by opening one or more first airflow apertures of the plurality of airflow apertures and closing one or more second airflow apertures of the plurality of airflow apertures. The rate and the direction of the fragrance dispersion are further controlled by modifying an effective open area of each of the plurality of airflow apertures. In one embodiment (see FIGS. 18A-18B and 19A-19B), the housing 10 includes one or more airflow-modifying structures 130-131—such as rotatable shutters, sliding covers, or adjustable louvers—that the user moves relative to the housing such that openings in the airflow-modifying structures 130-131 overlap with the plurality of airflow apertures to varying degrees, thereby selectively opening, closing, or modifying the effective open area of the plurality of apertures to regulate airflow through the diffusion medium 20. By restricting airflow, the user reduces the evaporation rate and extends fragrance duration; by opening the apertures fully, the user increases fragrance intensity. In other embodiments, the housing 10 may include directional vanes or baffles that direct airflow in a preferred direction, helical or spiral internal channels that create turbulence for enhanced diffusion, or replaceable diffusion inserts with different flow characteristics for customizing scent intensity.

### Cartridge and Refill Alternatives

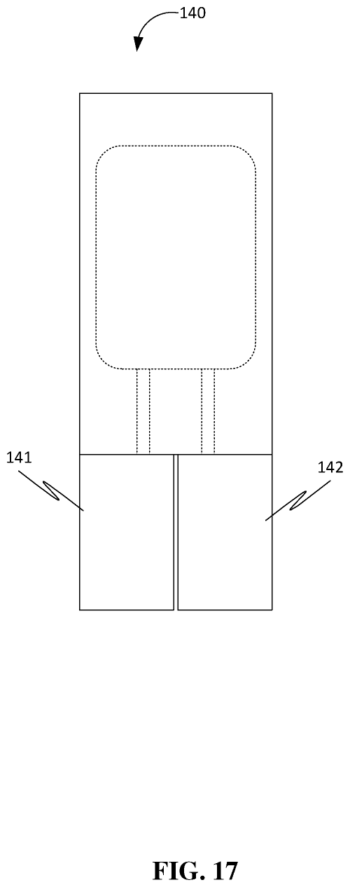

In addition to the refillable and replaceable cartridge configurations described above, the cartridge system may be configured in various alternative forms. Single-use disposable cartridges may be pre-filled by the manufacturer and sealed for retail distribution. Cartridges with different reservoir volumes may be offered for different use durations—for example, a smaller-capacity cartridge for trial or travel use and a larger-capacity cartridge for extended daily use. In some embodiments, the cartridge 40 includes multiple chambers for different scents, enabling the user to switch between fragrances or to blend scents by dispensing from more than one chamber (see FIG. 17, showing the fragrance cartridges 141-142). The cartridge may incorporate mechanical keying features—such as shaped flanges, notches, or color-coded indicators—that indicate cartridge type, scent family, or compatibility to the user or to the diffuser system. Cartridge retention mechanisms may include sliding, snap-fit, or twist-lock engagement in addition to the threaded connections described for the preferred embodiment.

### Electronic Variant

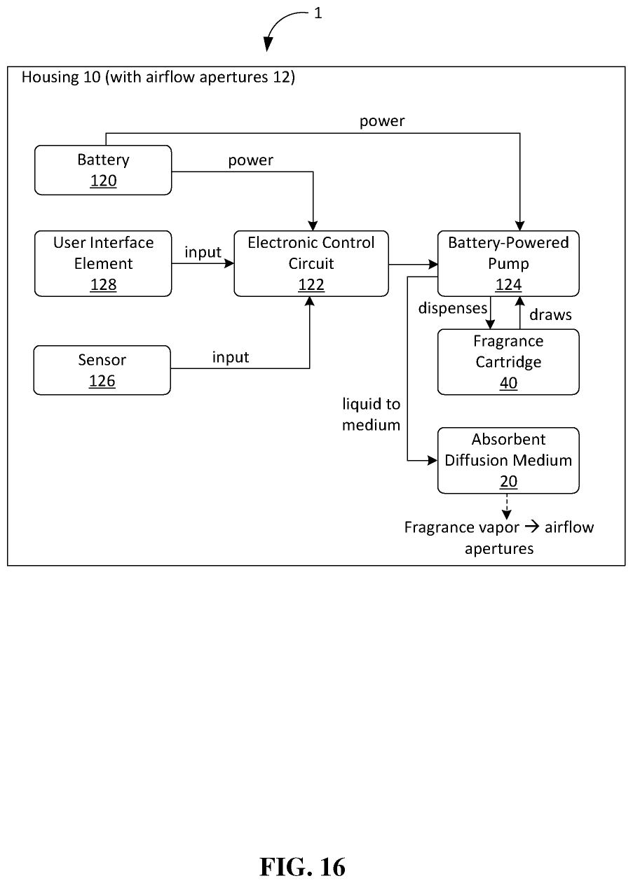

In an alternative embodiment illustrated schematically in FIG. 16, the manually-actuated pump mechanism described above is replaced with an electronically-actuated pump mechanism. Further, the electronically-actuated pump mechanism comprises a pump mechanism actuated using an electric actuator (i.e., motor, solenoid, etc.). In this configuration, the fragrance diffuser comprises a housing 10 defining an interior volume and having a plurality of airflow apertures 12; a fragrance cartridge 40 containing liquid fragrance, the cartridge 40 configured for removable attachment to the housing 10; an electronically-actuated pump mechanism comprising a battery-powered pump 124 and an electronic control circuit 122 configured to actuate the pump; and an absorbent diffusion medium 20 positioned within the housing 10 and configured to receive liquid fragrance dispensed by the pump.

Referring to FIG. 16, the electronic variant includes a battery 120 that provides electrical power to the control circuit 122 and pump 124. The control circuit 122 receives input from one or more sources and, in response, activates the pump 124 to dispense liquid fragrance from the cartridge 40 to the diffusion medium 20. The pump 124 may be a miniature electric pump, a solenoid-actuated valve, a piezoelectric pump, or any other electrically-driven fluid displacement device suitable for dispensing liquid fragrance in controlled quantities. Actuation of the pump 124 dispenses liquid fragrance directly to the absorbent diffusion medium 20, and fragrance evaporates from the diffusion medium 20 and exits the housing 10 through the airflow apertures 12, in the same manner as the manually-actuated embodiment.

In one embodiment, the electronic control circuit 122 includes a timer configured to actuate the battery-powered pump 124 at predetermined intervals to automatically dispense liquid fragrance to the absorbent diffusion medium 20. The predetermined intervals may be fixed (e.g., every 30 minutes, every hour) or may be user-adjustable. This timer-based operation provides a hands-free experience in which the diffuser automatically maintains fragrance intensity without user intervention.

In another embodiment, the electronic control circuit 122 is responsive to user input received via a user interface element 128 to actuate the battery-powered pump 124. The user interface element 128 may comprise one or more of: a mechanical button (which may be positioned similarly to the actuation button 14 of the manually-actuated embodiment), a touch-sensitive surface, or a capacitive sensor. The user interface element 128 provides on-demand electronic actuation, enabling the user to dispense fragrance with a button press or touch gesture rather than a mechanical pump stroke.

In a further embodiment, the electronic control circuit 122 is responsive to input from a sensor 126 to actuate the battery-powered pump 124 when motion or presence is detected. The sensor 126 may comprise a motion sensor, a proximity sensor, or both. In use, the sensor 126 detects the presence or movement of a person—for example, when a driver enters the vehicle or when a person walks past the diffuser in a room—and signals the control circuit 122 to dispense fragrance. This sensor-based operation provides automated, context-aware fragrance delivery.

Unlike some electronic fragrance diffusers that atomize and disperse fragrance liquid directly into the ambient air at low concentrations, the electronic variant of the present disclosure retains the diffusion medium architecture described throughout this specification. The liquid fragrance is dispensed to and absorbed by the diffusion medium 20, which then gradually releases fragrance through evaporation. This approach provides enhanced scent strength, longevity, and consistency compared to direct-air dispersal systems, while adding the convenience of electronic actuation and automated timing or sensing.

### Additional Alternative Features

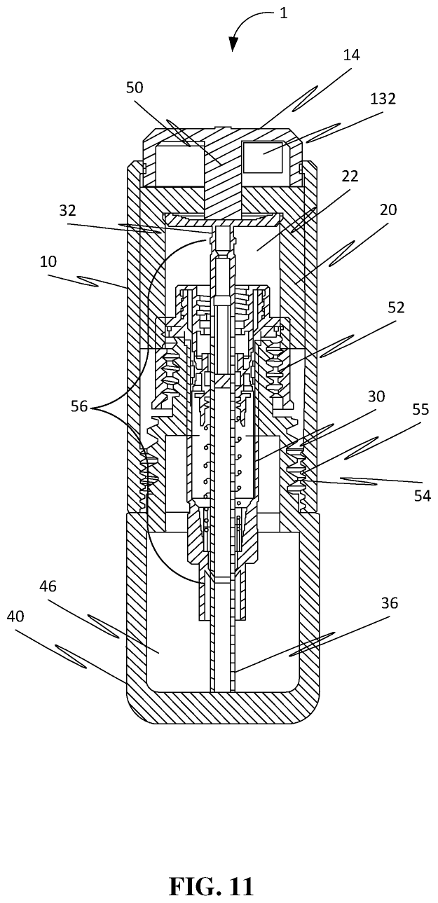

FIGS. 18A-18B illustrate the airflow-modifying structure 130. FIG. 11 illustrates an orientation sensor 132 positioned within the housing 10, which may be used in the electronic variant to detect diffuser orientation and inhibit pump actuation when the diffuser is inverted or tilted beyond a predetermined threshold, reducing the risk of over-dispensing. FIG. 7D illustrates a thermal interface 134 between the diffuser and a vehicle HVAC vent, whereby warm air from the vehicle heating system passes through or around the diffusion medium 20, increasing the evaporation rate and fragrance intensity. FIG. 17 illustrates a dual-cartridge configuration in which the diffuser includes cartridge bays, enabling the user to load two different fragrance cartridges 141-142 and selectively dispense from one or both. In some embodiments, the dual-cartridge configuration enables scent layering or alternating between scents.

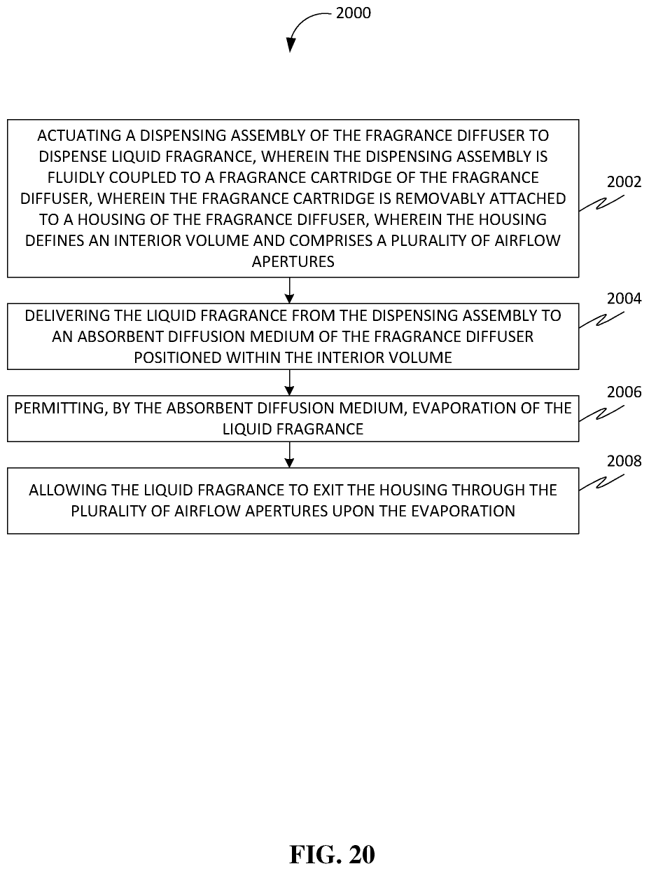

FIG. 20 is a flowchart of a method 2000 for controlled evaporative release of fragrance, in accordance with some embodiments. Further, the method 2000 includes a step 2002 of actuating a dispensing assembly of the fragrance diffuser to dispense liquid fragrance. Further, the dispensing assembly is fluidly coupled to a fragrance cartridge of the fragrance diffuser. Further, the fragrance cartridge is removably attached to a housing of the fragrance diffuser. Further, the housing defines an interior volume and includes a plurality of airflow apertures. Further, the method 2000 includes a step 2004 of delivering the liquid fragrance from the dispensing assembly to an absorbent diffusion medium of the fragrance diffuser positioned within the interior volume. Further, the method 2000 includes a step 2006 of permitting, by the absorbent diffusion medium, evaporation of the liquid fragrance. Further, the method 2000 includes a step 2008 of allowing the liquid fragrance to exit the housing through the plurality of airflow apertures upon the evaporation.

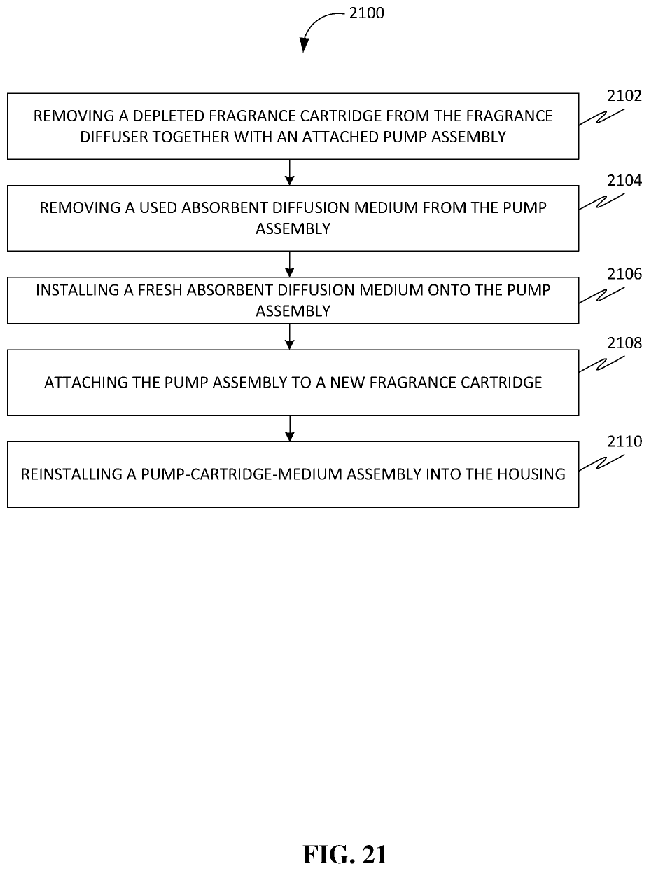

FIG. 21 is a flowchart of a method 2100 for controlled evaporative release of fragrance comprising reinstalling a pump-cartridge-medium assembly into the housing, in accordance with some embodiments. Further, the method 2100 may include a step 2102 of removing a depleted fragrance cartridge from the fragrance diffuser together with an attached pump assembly. Further, the method 2100 may include a step 2104 of removing a used absorbent diffusion medium from the pump assembly. Further, the method 2100 may include a step 2106 of installing a fresh absorbent diffusion medium onto the pump assembly. Further, the method 2100 may include a step 2108 of attaching the pump assembly to a new fragrance cartridge. Further, the method 2100 may include a step 2110 of reinstalling a pump-cartridge-medium assembly into the housing.

Although the present disclosure has been explained in relation to its preferred embodiment, it is to be understood that many other possible modifications and variations can be made without departing from the spirit and scope of the disclosure.

What is claimed is:

1. A fragrance diffuser comprising:
a housing defining an interior volume and having a plurality of airflow apertures;
a fragrance cartridge containing liquid fragrance, the fragrance cartridge configured to be removably attached to the housing;
a dispensing assembly fluidly coupled to the fragrance cartridge, wherein the dispensing assembly is configured to dispense the liquid fragrance upon actuation of the dispensing assembly; and
an absorbent diffusion medium positioned within the interior volume, wherein the absorbent diffusion medium is configured to receive the liquid fragrance delivered by the dispensing assembly, wherein the absorbent diffusion medium is configured to permit evaporation of the liquid fragrance, and wherein the liquid fragrance exits the housing through the plurality of airflow apertures upon evaporation.

2. The fragrance diffuser of claim 1, wherein the dispensing assembly comprises a manually-actuated pump mechanism configured to dispense the liquid fragrance upon manual actuation, the manually-actuated pump mechanism requiring no electrical power.

3. The fragrance diffuser of claim 2, wherein the manually-actuated pump mechanism comprises a push-down liquid dispenser having a pump head, and wherein the absorbent diffusion medium is positioned in direct contact with or immediately adjacent to the pump head such that dispensed liquid fragrance is absorbed by the absorbent diffusion medium without pooling in an open reservoir.

4. The fragrance diffuser of claim 1, wherein the dispensing assembly comprises a valve-based dispensing system comprising one or more valves configured to seal the fragrance cartridge in a closed position, and an actuator configured to open the one or more valves when engaged, wherein the liquid fragrance flows by gravity from the fragrance cartridge through the opened one or more valves into the absorbent diffusion medium when the fragrance diffuser is inverted and the actuator is engaged.

5. The fragrance diffuser of claim 1, wherein the dispensing assembly comprises an electronically-actuated pump mechanism comprising a battery-powered pump and an electronic control circuit configured to actuate the battery-powered pump.

6. The fragrance diffuser of claim 5, wherein the electronic control circuit includes a timer configured to actuate the battery-powered pump at predetermined intervals to automatically dispense the liquid fragrance to the absorbent diffusion medium.

7. The fragrance diffuser of claim 5, wherein the electronic control circuit is responsive to a user input received via a user interface element to actuate the battery-powered pump, the user interface element comprising one or more of: a mechanical button, a touch-sensitive surface, or a capacitive sensor.

8. The fragrance diffuser of claim 5, wherein the electronic control circuit is responsive to an input from a motion sensor or a proximity sensor to actuate the battery-powered pump when motion or presence is detected.

9. The fragrance diffuser of claim 1, wherein the absorbent diffusion medium has an annular configuration defining a hollow core, and wherein a force transmission element extends through the hollow core to transmit actuation force from an actuation element to the dispensing assembly, wherein the fragrance diffuser comprises the force transmission element and the actuation element.

10. The fragrance diffuser of claim 9, wherein the force transmission element comprises a plunger or a rod that extends from the actuation element, through the hollow core of the absorbent diffusion medium, to engage a pump head of the dispensing assembly.

11. The fragrance diffuser of claim 9, wherein the force transmission element comprises an extension integrally formed with or attached to the dispensing assembly, the extension extending upward through the hollow core to contact the actuation element.

12. The fragrance diffuser of claim 1, wherein the absorbent diffusion medium has sufficient structural rigidity to transmit compressive force, and wherein the absorbent diffusion medium itself serves as a force transmission element such that depression of an actuation element compresses the absorbent diffusion medium to actuate the dispensing assembly, wherein the fragrance diffuser comprises the actuation element.

13. The fragrance diffuser of claim 1, wherein the dispensing assembly has a single outlet, and wherein the liquid fragrance dispensed from the single outlet is distributed throughout the absorbent diffusion medium by capillary wicking action.

14. The fragrance diffuser of claim 1, wherein the dispensing assembly includes a liquid distribution structure configured to deliver the liquid fragrance to a plurality of spatially separated locations within the absorbent diffusion medium.

15. The fragrance diffuser of claim 14, wherein the liquid distribution structure comprises a plurality of radial tubes extending outward from a pump stem, the plurality of radial tubes configured to deliver the liquid fragrance into an interior region of the absorbent diffusion medium.

16. The fragrance diffuser of claim 14, wherein the liquid distribution structure comprises a dish element having a plurality of apertures through which the liquid fragrance emerges for absorption by the absorbent diffusion medium.

17. The fragrance diffuser of claim 14, wherein the liquid distribution structure comprises channels or grooves configured to direct liquid fragrance radially outward from a central dispensing point into the absorbent diffusion medium.

18. The fragrance diffuser of claim 14, further comprising one or more holding chambers positioned at outlets of the liquid distribution structure, the one or more holding chambers configured to temporarily retain the liquid fragrance in excess of the absorbent diffusion medium's immediate absorption capacity, wherein the liquid fragrance is drawn from the one or more holding chambers into the absorbent diffusion medium by capillary action.

19. The fragrance diffuser of claim 1, further comprising a magnetic interface on a surface of the housing, and a vent clip having a corresponding magnetic element, wherein the housing is magnetically attachable to and detachable from the vent clip for mounting the fragrance diffuser to a vehicle air vent.

20. The fragrance diffuser of claim 1, wherein the absorbent diffusion medium comprises a material selected from the group consisting of cellulose, ceramic, pressed paperboard, cotton, rattan, polyester, polyethylene, and combinations thereof.

21. The fragrance diffuser of claim 1, wherein the fragrance cartridge is constructed of transparent or translucent material to permit visual monitoring of the liquid fragrance's level.

22. A fragrance diffuser comprising:
a housing defining an interior volume and having a plurality of airflow apertures;
a fragrance cartridge containing liquid fragrance, the fragrance cartridge configured to be removably attached to the housing;
a dispensing assembly fluidly coupled to the fragrance cartridge, the dispensing assembly comprising a pump mechanism configured to dispense liquid fragrance through an outlet upon actuation;
an absorbent diffusion medium positioned within the interior volume and configured to receive the liquid fragrance at the outlet, wherein the absorbent diffusion medium is configured to permit evaporation of the liquid fragrance, and wherein the liquid fragrance exits the housing through the plurality of airflow apertures upon evaporation; and
an actuation element operatively coupled with the dispensing assembly, wherein the actuation element is configured for actuating the dispensing assembly.

23. The fragrance diffuser of claim 22, further comprising a force transmission element configured to transmit actuation force from the actuation element to the pump mechanism, the force transmission element extending through or around the absorbent diffusion medium.

24. The fragrance diffuser of claim 22, wherein the dispensing assembly includes a liquid distribution structure configured to deliver liquid fragrance to a plurality of spatially separated locations within the absorbent diffusion medium.

25. A fragrance diffuser system comprising:
a diffuser shell having a plurality of airflow perforations and an attachment interface;
a fragrance cartridge having a first neck and a second neck, the first neck configured for attachment to a pump assembly and the second neck configured for attachment to the diffuser shell;
a pump assembly attached to the first neck of the fragrance cartridge, forming a pump-cartridge subassembly; and
an absorbent diffusion medium positioned around or adjacent to an output region of the pump assembly;
wherein the pump-cartridge subassembly is removably attachable to the diffuser shell via engagement between the second neck and the attachment interface, and wherein the pump-cartridge subassembly and the absorbent diffusion medium are removable from the diffuser shell as a unit for replacement of the absorbent diffusion medium or the fragrance cartridge without requiring tools.

26. The fragrance diffuser system of claim 25, wherein the first neck attaches to the pump assembly via threaded engagement, and wherein the second neck attaches to the diffuser shell via threaded engagement.

27. The fragrance diffuser system of claim 25, wherein at least one of the attachment between the first neck and the pump assembly or the attachment between the second neck and the diffuser shell comprises a snap-fit connection, bayonet twist-lock mechanism, or friction-fit interface.

28. The fragrance diffuser system of claim 25, wherein the attachment between the first neck and the pump assembly is of a first attachment type, and the attachment between the second neck and the diffuser shell is of a second attachment type different from the first attachment type.

29. The fragrance diffuser system of claim 25, wherein the first neck and the second neck are axially stacked along a longitudinal axis of the fragrance cartridge, with the first neck positioned above the second neck.

30. The fragrance diffuser system of claim 25, wherein the first neck and the second neck are concentrically arranged on a common plane perpendicular to a longitudinal axis of the fragrance cartridge, with the first neck positioned radially inward of the second neck.

31. The fragrance diffuser system of claim 25, wherein the absorbent diffusion medium is configured as a sleeve that slides over the pump assembly's output region, and wherein the absorbent diffusion medium is replaceable by sliding the sleeve off the pump assembly and replacing it with a new absorbent diffusion medium.

32. A mounting system for a fragrance diffuser, comprising:
a diffuser body;
a loop element rotatably attached to the diffuser body, the loop element being movable between at least a first position and a second position;
wherein in the first position, the loop element extends in a first orientation enabling suspension of the fragrance diffuser from a cord, strap, or hook; and
wherein in the second position, the loop element extends in a second orientation approximately perpendicular to the first orientation, enabling attachment to a vent clip or magnetic mount.

33. The mounting system of claim 32, further comprising a magnetic interface on the loop element, wherein the magnetic interface enables magnetic attachment of the loop element to a magnetically-receptive vent clip, a magnetically-receptive cord, strap, hook, or hanging mount, or other magnetically-receptive surface.

34. The mounting system of claim 32, wherein the loop element includes one or more detent positions providing tactile feedback and positional retention at the first position and the second position.

35. A method of emitting fragrance using a fragrance diffuser, the method comprising:
actuating a dispensing assembly of the fragrance diffuser to dispense liquid fragrance, wherein the dispensing assembly is fluidly coupled to a fragrance cartridge of the fragrance diffuser, wherein the fragrance cartridge is removably attached to a housing of the fragrance diffuser, wherein the housing defines an interior volume and comprises a plurality of airflow apertures;
delivering the liquid fragrance from the dispensing assembly to an absorbent diffusion medium of the fragrance diffuser positioned within the interior volume;
permitting, by the absorbent diffusion medium, evaporation of the liquid fragrance; and
allowing the liquid fragrance to exit the housing through the plurality of airflow apertures upon the evaporation.

36. The method of claim 35, wherein the liquid fragrance is distributed to a plurality of locations within the absorbent diffusion medium via a liquid distribution structure comprising radial tubes, a plurality of apertures, channels, or a branching distribution structure.

37. The method of claim 35, further comprising:
removing a depleted fragrance cartridge from the fragrance diffuser together with an attached pump assembly;
removing a used absorbent diffusion medium from the pump assembly;
installing a fresh absorbent diffusion medium onto the pump assembly;
attaching the pump assembly to a new fragrance cartridge; and
reinstalling a pump-cartridge-medium assembly into the housing.
